(19) United States
(12) Patent Application Publication
(10) Pub. No.: US 2024/0186674 A1
(43) Pub. Date: Jun. 6, 2024

(54) Resonance Unit and Dielectric Filter

(71) Applicants: WUGUANG SYSTEM COMPANY LIMITED, Hong Kong (CN); ACCULA ELECTRONIC TECHNOLOGIES PTE. LTD, Singaporre (SG); AVALEN INFO SYSTEM TECHNOLOGIES COMPANY LIMITED, Vancouver, British Columbia (CA)

(72) Inventor: Qingnan MENG, Hong Kong (CN)

(21) Appl. No.: 17/799,285

(22) PCT Filed: May 28, 2021
(86) PCT No.: PCT/CN2021/096884

§ 371 Date: Aug. 12, 2022

(30) Foreign Application Priority Data
Aug. 7, 2020 (CN) 202010789774.2

(51) Int. Cl. H01P 7/06; H01P 1/20; H01P 7/10

(52) U.S. Cl. CPC H01P 7/06; H01P 1/2002; H01P 7/10

(57) ABSTRACT

A dielectric resonance unit of an embodiment of the present disclosure includes a cavity, a supporting frame, a resonator, and a cover plate. The cavity is a sealed space. One surface of the cavity is a cover plate surface; the resonator is composed of a dielectric resonance block and a resonance bar; the resonator is mounted in the cavity; and the supporting frame is mounted at any position between the resonator and an inner wall of the cavity and is matched with any shape of the resonator and the cavity for connection and fixing. At least one hole for accommodating the resonance bar is provided on the dielectric resonance block. The resonance bar and the dielectric resonance block are non-electrically connected. In the embodiments of the present disclosure, the dielectric resonance block is provided with a through hole or a blind hole; a dielectric resonance bar or a metal resonance bar is put into the through hole and the blind hole to reduce the frequency, which effectively

### TECHNICAL FIELD

Embodiments of the present disclosure relate to the technical field of communications, in particular to a resonance unit and a dielectric filter.

### BACKGROUND

In recent years, as an important part of a communication antenna feed system, a filter is an inescapable key device. The research on the filter is also making new progress. A filter is a filter circuit composed of a capacitor, an inductor, and a resistor. The filter can effectively filter out a frequency point of a specific frequency in a power line or frequencies other than the frequency point to obtain a power signal with a specific frequency, or eliminate a power signal after one specific frequency. With the development of mobile communication technologies, the requirements for filters are getting higher and higher, such as low frequency, low cost, high power, high performance, and the like. In particular, the demand for product miniaturization is becoming more and more extensive. Especially for low-frequency products, the volume of the traditional design is too large to meet new market demands. For a long time, people have been exploring how to reduce the volume of a low-frequency product. Common methods for reducing the frequency are using a metal resonance bar and a metal disk. However, in the case of a small volume, the single-cavity Q value cannot be improved, resulting in high insertion loss. In addition, the Q value can be improved through a TE-mode or TM-mode dielectric resonator, but it cannot meet the requirements for small volume and low frequency, and the high cost of the dielectric resonator limits its application range. Therefore, how to greatly reduce the frequency while maintaining the small volume of a single cavity is a problem to be solved by a base station filter supplier in the face of market challenges.

### SUMMARY

In order to solve the above-mentioned problem, embodiments of the present disclosure provide a resonance unit and a dielectric filter, which can greatly reduce a single-cavity frequency while maintaining a higher Q value and a volume of a filter unchanged.

An embodiment of the present disclosure discloses a resonance unit, including a cavity, a supporting frame, a resonator, and a cover plate. The cavity is a sealed space. One surface of the cavity is a cover plate surface; the resonator is composed of a dielectric resonance block and a resonance bar; the resonator is mounted in the cavity; and the supporting frame is mounted at any position between the resonator and an inner wall of the cavity and is matched with any shape of the resonator and the cavity for connection and fixing. When one axial direction of the dielectric resonance block in the resonator is a through hole, the dielectric resonance block is mounted in the cavity and is in no contact with the inner wall of the cavity; or, one end of the dielectric resonance block is in contact with the inner wall of the cavity; or, two ends of the dielectric resonance block in the same axial direction are in contact with the inner wall of the cavity; a metal resonance bar or a dielectric resonance bar is mounted in the through hole of the dielectric resonance block; one end is in contact or in no contact with the inner wall of the cavity, and the other end is in no contact with the inner wall of the cavity, and/or the end which is in no contact with the inner wall of the cavity is provided with a flange plate; a surface of the flange plate of the dielectric resonance bar is metalized; two ends of the dielectric resonance bar in the same axial direction are in contact with the inner wall of the cavity to form an integrated resonator; and any vertical axial direction of the dielectric resonance block and the metal resonance bar or the dielectric resonance bar are combined to achieve a resonance structure with a single axial direction. When one axial direction of the dielectric resonance block in the resonator is a blind hole, the dielectric resonance block is mounted in the cavity and is in no contact with the inner wall of the cavity; or, one end of the dielectric resonance block is in contact with the inner wall of the cavity; or, two ends of the dielectric resonance block in the same axial direction are in contact with the inner wall of the cavity; a metal resonance bar or a dielectric resonance bar is mounted in the blind hole; the other end is in contact with the inner wall of the cavity is not in contact with the inner wall of the cavity, and/or the end which is in no contact with the inner wall of the cavity is provided with a flange plate to form an integrated resonator; and any vertical axial direction of the dielectric resonance block and the metal resonance bar or the dielectric resonance bar are combined to achieve a resonance structure with a single axial direction. When the dielectric resonance block in the resonator is solid or one axial direction is a blind hole, one end of the metal resonance bar in the same axial direction is mounted on a surface of the dielectric resonance block or in the blind hole; the other end is in contact with the inner wall of the cavity; a metal resonance bar is mounted on one or two surfaces corresponding to the same axial direction of the dielectric resonance block, or is mounted on surfaces corresponding to different axial directions of the dielectric resonance block, or one or more metal resonance bars are mounted on different axial surfaces of the dielectric resonance block or in the blind hole to form an integrated resonator; any vertical axial direction of the dielectric resonance block and the metal resonance bar or the dielectric resonance bar are combined to achieve a resonance structure with a single axial direction; and a cylindrical or polygonal resonator with a single axial direction and a fixed supporting frame thereof are arranged in the cavity, so as to form a single-mode or multi-mode resonance unit together with the cavity. Or, two vertically intersecting cylindrical or polygonal resonators with single axial directions and a fixed supporting frame thereof are arranged in the cavity, so as to form a single-mode or multi-mode resonance unit together with the cavity. The X-axial dimension of the cylindrical or polygonal resonator in the X-axis direction is greater than or equal to the perpendicular dimension, parallel to the X-axial direction, of the cylindrical or polygonal resonator with a Y axis. The Y-axial dimension of the cylindrical or polygonal resonator in the Y-axis direction is greater than or equal to the perpendicular dimension, parallel to the Y-axial direction, of the cylindrical or polygonal resonator with an X axis. Or, three vertically intersecting cylindrical or polygonal resonators with single axial directions and a fixed supporting frame thereof are arranged in the cavity, so as to form a single-mode or multi-mode resonance unit together with the cavity. The X-axial dimension of the cylindrical or polygonal resonator in the e X-axis direction is greater than or equal to the perpendicular dimensions, parallel to the X-axial direction, of the cylindrical or polygonal resonator with a Y axis and the cylindrical or polygonal resonator with a Z axis. The Y-axial dimension of the cylindrical or polygonal resonator in the Y-axis direction is greater than or equal to the perpendicular dimensions, parallel to the Y-axial direction, of the cylindrical or polygonal resonator with an X axis and the cylindrical or polygonal resonator with the Z axis. The Z-axial dimension of the cylindrical or polygonal resonator in the Z-axis direction is greater than or equal to the perpendicular dimensions, parallel to the Z-axial direction, of the cylindrical or polygonal resonator with the X axis and the cylindrical or polygonal resonator with the Y axis. When the resonance unit is a resonator with a single axial direction, vertically intersecting resonators with single axial directions, or three mutually vertically intersecting resonators with single axial directions, the resonator is subjected to edge cutting, slotting, and corner cutting in horizontal and vertical directions, so that the dimension of the inner wall of the cavity and the dimensions of the resonators corresponding to three axial directions change or the dimensions in the horizontal and vertical directions change, so as to change frequency of a fundamental mode and the frequency of a plurality of high-order modes, the number of corresponding multimodes and Q values. When the resonance unit is vertically intersecting resonators with single axial directions or three mutually vertically intersecting resonators with single axial directions, and when the dimension of the cylindrical or polygonal resonator in any one axial direction is less than the perpendicular dimensions, parallel to the axial direction, of the cylindrical or polygonal resonators in the other one or two axial directions, the frequencies and Q values of the fundamental mode and the plurality of high-order modes corresponding to the resonators will correspondingly change. When the frequency of the fundamental mode remains unchanged, the resonance unit is composed of the resonators with different dielectric constants, the cavity and the supporting frame; the single modes, the multimodes and the Q values corresponding to the frequencies of the fundamental mode and the plurality of high-order modes will change; the Q values of the resonators with different dielectric constants change differently; and the frequencies of the high-order modes will also change.

In one preferable implementation solution of the present disclosure, a resonance unit with a single axial direction or two mutually vertically intersecting resonance units with single axial directions or three mutually vertically intersecting resonance units with single axial directions are provided; when one axial direction of the dielectric resonance block in the resonator is a through hole, the dielectric resonance block is mounted in the cavity and is in no contact with the inner wall of the cavity, or one end of the dielectric resonance block is in contact with the inner wall of the cavity, or two ends of the dielectric resonance block in the same axial direction are in contact with the inner wall of the cavity; the metal resonance bar is mounted in the through hole; one end is in contact with the inner wall of the cavity, and the other end is in no contact with the inner wall and is provided with a flange plate, so as to form an integrated resonator; or the metal resonance bar is mounted in the through hole, and two ends are in no contact with the inner wall of the cavity, so as to combine an integrated dielectric and metal resonator; a gap is reserved between the metal resonance bar and the inner wall of the through hole of the dielectric resonance block, or the metal resonance bar is completely fitted to the inner wall of the through hole; the metal resonance bar may be mounted in different axial directions of the dielectric resonance block and may be a single-axis, vertically intersecting double-axis or mutually vertically intersecting three-axis metal resonance bar; a frequency corresponding to an axial direction of the metal resonance bar decreases; the flange plate at one end of the metal resonance bar further reduces the frequency; and the decrease of the frequency when the metal resonance bar in the through hole of the dielectric resonance block is completely fitted to the inner wall of the through hole is greater than the decrease of the frequency when there is a gap.

In one preferable implementation solution of the present disclosure, a resonance unit with a single axial direction or two mutually vertically intersecting resonance units with single axial directions or three mutually vertically intersecting resonance units with single axial directions are provided; when one axial direction of the dielectric resonance block in the resonator is a through hole, the dielectric resonance block is mounted in the cavity and is in no contact with the inner wall of the cavity, or one end of the dielectric resonance block is in contact with the inner wall of the cavity, or two ends of the dielectric resonance block in the same axial direction are in contact with the inner wall of the cavity; the dielectric resonance bar is mounted in the through hole; one end or two ends corresponding to the axial direction is in contact with the inner wall of the cavity; when one end corresponding to the axial direction is in contact with the inner wall, the other end is in no contact with the inner wall, and a surface-metalized dielectric flange plate is added on the end surface of the end, so as to form an integrated resonator; or the dielectric resonance bar is mounted in the through hole of the dielectric resonance block, and two ends of the dielectric resonance bar are in no contact with the inner wall of the cavity, so as to combine an integrated dielectric and metal resonator; a gap is reserved between the inner wall of the through hole of the dielectric resonance block and the dielectric resonance bar, or the metal resonance bar is completely fitted to the inner wall of the through hole; the dielectric resonance bar is mounted in any axial direction of the dielectric resonance block or may be a single-axis, vertically intersecting double-axis or mutually vertically intersecting three-axis dielectric resonance bar; a frequency corresponding to an axial direction when the end surface of the dielectric resonance bar is in contact with the inner wall decreases; the metallization of the flange plate at one end of the dielectric resonance bar further reduces the frequency; and the decrease of the frequency when the metal resonance bar in the through hole of the dielectric resonance block is completely fitted to the inner wall of the through hole is greater than the decrease of the frequency when there is a gap.

In one preferable implementation solution of the present disclosure, a resonance unit with a single axial direction or two mutually vertically intersecting resonance units with single axial directions or three mutually vertically intersecting resonance units with single axial directions are provided; when one axial direction of the dielectric resonance block in the resonator is a blind hole, the dielectric resonance block is mounted in the cavity and is in contact with the inner wall of the cavity, or one end of the dielectric resonance block is in contact with the inner wall of the cavity, or two ends of the dielectric resonance block in the same axial direction are in contact with the inner wall of the cavity; the metal resonance bar is mounted in the blind hole; one end is in contact with the inner wall of the cavity, and the other end is provided with a flange plate, so as to form an integrated resonator; or the metal resonance bar is mounted in the blind hole, and two ends are both in no contact with the inner wall of the cavity, so as to combine an integrated dielectric and metal resonator; a gap is reserved between the metal resonance bar and the inner wall of the blind hole of the dielectric resonance block, or the metal resonance bar is fitted to the inner wall of the blind hole; the metal resonance bar is mounted in different axial directions of the dielectric resonance block, or is a single-axis, vertically intersecting double-axis or mutually vertically intersecting three-axis metal resonance bar; a frequency corresponding to an axial direction of the metal resonance bar decreases; the flange plate at one end of the metal resonance bar further reduces the frequency; and the decrease of the frequency when the metal resonance bar in the blind hole of the dielectric resonance block is completely fitted to the inner wall of the blind hole is greater than the decrease of the frequency when there is a gap.

In one preferable implementation solution of the present disclosure, a resonance unit with a single axial direction or two mutually vertically intersecting resonance units with single axial directions or three mutually vertically intersecting resonance units with single axial directions are provided; when one axial direction of the dielectric resonance block in the resonator is a blind hole, the dielectric resonance block is mounted in the cavity and is in no contact with the inner wall of the cavity, or one end of the dielectric resonance block is in contact with the inner wall of the cavity, or two ends of the dielectric resonance block in the same axial direction are in contact with the inner wall of the cavity; the metal resonance bar is mounted in the blind hole; one end or two ends corresponding to the axial direction is in contact with the inner wall of the cavity, so as to form an integrated resonator; or the dielectric resonance bar is mounted in the blind hole of the dielectric resonance block, and the dielectric resonance bar is in no contact with the inner wall of the cavity, so as to combine an integrated resonator; a gap is reserved between the dielectric resonance bar and the inner wall of the blind hole of the dielectric resonance block, or the dielectric resonance bar is completely fitted to the inner wall of the blind hole; the dielectric resonance bar is mounted in any axial direction of the dielectric resonance block or is a single-axis, vertically intersecting double-axis or mutually vertically intersecting three-axis dielectric resonance bar; a frequency corresponding to an axial direction decreases when the end surface of the dielectric resonance bar is grounded; and the decrease of the frequency when the dielectric resonance bar in the blind hole of the dielectric resonance block is completely fitted to the inner wall of the blind hole is greater than the decrease of the frequency when there is a gap.

In one preferable implementation solution of the present disclosure, a resonance unit with a single axial direction or two mutually vertically intersecting resonance units with single axial directions or three mutually vertically intersecting resonance units with single axial directions are provided; when the dielectric resonance block in the resonator is solid or one axial direction is a blind hole, one end of the metal resonance bar in the same axial direction is mounted on a surface of the dielectric resonance block or in the blind hole, and the other end is in contact with the inner wall of the cavity; or the metal resonance bar is mounted on a surface corresponding to the same axial direction of the dielectric resonance block or is mounted on surfaces corresponding to different axial directions of the dielectric resonance bar; or one or more metal resonance bars are mounted on different axial surfaces of the dielectric resonance block or in the blind hole, so as to form an integrated resonator; the dielectric resonance bar is mounted in any axial direction of the dielectric resonance block, or is a single-axis, vertically intersecting double-axis or mutually vertically intersecting three-axis dielectric resonance bar; and a frequency corresponding to the axial direction when the end surface of the dielectric resonance bar is in contact decreases.

In one preferable implementation solution of the present disclosure, one cylindrical or polygonal resonator with a single axial direction and a fixed supporting frame thereof are arranged in the cavity to form a single-mode or multi-mode dielectric resonance structure together with the cavity; the center of the end surface of the resonator is close to or overlaps the center position of an inner wall surface corresponding to the cavity; the resonator is subjected to edge cutting, slotting, and corner cutting in horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of multiple high-order modes, the number of corresponding multimodes and Q values. When the X, Y, and Z-axial dimensions of the inner wall of the cavity change, the X, Y, and Z-axial dimensions of the resonator corresponding to the inner wall of the cavity will also correspondingly change while maintaining at least one required frequency unchanged. Two vertically intersecting cylindrical or polygonal resonators with single axial directions and a fixed supporting frame thereof are arranged in the cavity, so as to form a single-mode or multi-mode dielectric resonance structure together with the cavity, and the center of the end surface of the resonator is close to or overlaps the center position of an inner wall surface corresponding to the cavity. The X-axial dimension of the cylindrical or polygonal resonator in the X-axis direction is greater than or equal to the perpendicular dimension, parallel to the X-axial direction, of the cylindrical or polygonal resonator with a Y axis. The Y-axial dimension of the cylindrical or polygonal resonator in the Y-axis direction is greater than or equal to the perpendicular dimension, parallel to the Y-axial direction, of the cylindrical or polygonal resonator with an X axis. The resonator is trimmed, slotted and chamfered in the horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of multiple high-order modes, the number of corresponding multimodes and Q values. When the X, Y, and Z-axial dimensions of the inner wall of the cavity change, the X, Y, and Z-axial dimensions of the resonator corresponding to the inner wall of the cavity will also correspondingly change while maintaining at least one required frequency unchanged. Three vertically intersecting cylindrical or polygonal resonators with single axial directions and a fixed supporting frame thereof are arranged in the cavity, so as to form a single-mode or multi-mode dielectric resonance structure together with the cavity, and the center of the end surface of the resonator is close to or overlaps the center position of an inner wall surface corresponding to the cavity. The X-axial dimension of the cylindrical or polygonal resonator in the X-axis direction is greater than or equal to the perpendicular dimensions, parallel to the X-axial direction, of the cylindrical or polygonal resonator with a Y axis and the cylindrical or polygonal resonator with a Z axis. The Y-axial dimension of the cylindrical or polygonal resonator in the Y-axis direction is greater than or equal to the perpendicular dimensions, parallel to the Y-axial direction, of the cylindrical or polygonal resonator with the X axis and the cylindrical or polygonal resonator with the Z axis. The Z-axial dimension of the cylindrical or polygonal resonator in the Z-axis direction is greater than or equal to the perpendicular dimensions, parallel to the Z-axial direction, of the cylindrical or polygonal resonator with the X axis and the cylindrical or polygonal resonator with the Y axis. The resonator is subjected to edge cutting, slotting, and corner cutting in the horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of multiple high-order modes, the number of corresponding multimodes and Q values. When the X, Y, and Z-axial dimensions of the inner wall of the cavity change, the X, Y, and Z-axial dimensions of the resonator corresponding to the inner wall of the cavity will also correspondingly change while maintaining at least one required frequency unchanged.

In one preferable implementation solution of the present disclosure, a resonance unit with a single axial direction or two mutually vertically intersecting resonance units with single axial directions or three mutually vertically intersecting resonance units with single axial directions are provided; when the dimensions of the cavities corresponding to the dimensions of one axial resonator in the resonators and the other one or two axial resonators or the three axial resonators and the dimensions of the corresponding cavities change, the numbers and frequencies of the corresponding fundamental modes and multimodes and the Q values will also correspondingly change; the decrease of the frequency when the metal resonance bar and the dielectric resonance bar in the through hole of the dielectric resonance block are completely fitted is greater than the decrease of the frequency when there is a gap; when the end surfaces of the metal resonance bar and the dielectric resonance bar are in contact with the inner wall of the cavity, the frequency decreases; after the flange plate is added on the end surfaces of the metal resonance bar and the dielectric resonance bar, the frequency is further reduced; and if the flange plate has a larger area, the frequency decreases more.

In one preferable implementation solution of the present disclosure, a resonance unit with a single axial direction or two mutually vertically intersecting resonance units with single axial directions or three mutually vertically intersecting resonance units with single axial directions are provided; when the dimension of the inner wall of the cavity and the dimensions of the resonators corresponding to three axial directions change or the dimensions in the horizontal and vertical directions change, the multimodes and Q values corresponding to the frequency of the fundamental mode and the frequency of multiple high-order modes will change; and the frequencies corresponding to the resonators with different dielectric constants, and the Q values change differently.

In one preferable implementation solution of the present disclosure, a resonance unit with a single axial direction or two mutually vertically intersecting resonance units with single axial directions or three mutually vertically intersecting resonance units with single axial directions are provided; when the dimension of the inner wall of the cavity and the dimensions of the resonators corresponding to the three axial directions change or the dimensions in the horizontal and vertical directions change, while the frequency of the fundamental mode remains unchanged, spans between the frequencies of the high-order modes and the frequency of the fundamental mode as well as spans between the frequencies of the high-order modes change for multiple times; spans between the frequencies of the resonators with different dielectric constants change differently; when the dimensions of the cavities corresponding to the dimensions of one axial resonator and the other one or two axial resonators or the dimensions of the three axial resonators change, the spans between the frequency of the corresponding fundamental mode and the frequencies of the multimodes will also correspondingly change.

In one preferable implementation solution of the present disclosure, a resonance unit with a single axial direction or two mutually vertically intersecting resonance units with single axial directions or three mutually vertically intersecting resonance units with single axial directions are provided; when the dimension of the inner wall of the cavity and the dimensions of the resonators corresponding to the three axial directions change or the dimensions in the horizontal and vertical directions change, while the dimension of the cavity and the frequency of the fundamental mode remain unchanged, the fundamental mode and the high-order modes of the resonance unit may form at least one multimode with the same frequency or with close frequencies; when the dimensions of the cavities corresponding to the dimensions of one axial resonator and the other one or two axial resonators or the dimensions of the three axial resonators change, the number of the corresponding fundamental modes and the number of the corresponding multimodes will also correspondingly change.

In one preferable implementation solution of the present disclosure, the resonator or cavity is cut at structural position perpendicular to an electric field or magnetic field or an edge is added, so as to form an adjacent coupling, and the cavity and the resonator are cut into triangles or quadrangles; or the edge of the cavity or the resonator is partially or overall cut off or added; the cavity and the resonator are simultaneously or separately subjected to edge cutting; after the adjacent coupling is formed by edge cutting, the frequencies and the Q values will correspondingly change; the adjacent coupling is changed into intersecting coupling; intersecting structural positions of three resonance axial electric fields or magnetic fields formed by intersecting three surfaces of the cavities corresponding to the single axial resonator and the other one or two axial resonators are subjected to corner cutting or supplementation or are subjected to corner cutting and supplementation and closed with the corresponding cavities to form the intersecting coupling, and the corresponding frequencies and Q values will also correspondingly change; at the same time, the adjacent coupling is changed; and when the corners and edges of the resonators are slotted or perforated or protrude, the strength of the adjacent coupling and the strength of the intersecting coupling are changed.

In one preferable implementation solution of the present disclosure, at least one tuning device is arranged at a position with concentrated field strength of the resonator.

In one preferable implementation solution of the present disclosure, a resonance unit with a single axial direction or two mutually vertically intersecting resonance units with single axial directions or three mutually vertically intersecting resonance units with single axial directions are provided; the shape of the corresponding cavity includes at least one of the following: a cuboid, a cube, and a polygon; the surface of the inner wall of the cavity or part of an internal region may be set to be a recess or a protrusion or a cut corner or a slot; at least one tuning device is arranged at a position with concentrated field strength of the dielectric resonator and is mounted on the cavity; a material of the cavity is metal or non-metal; the surface of the cavity is electroplated with copper or silver; and the cavities in different shapes will affect the Q values, the frequencies, and the number of modes.

In one preferable implementation solution of the present disclosure, shapes combined by the cross sections of a resonance unit with a single axial direction or two mutually vertically intersecting resonance units with single axial directions or three mutually vertically intersecting resonance units with single axial directions and a vertical axial direction include at least one of the following: a cylinder, an ellipsoid, a cube, a cuboid, and a polygon; the resonance unit is set to be solid or hollow; the dielectric resonance block is provided with a through hole and a blind hole, and slots or holes are formed in the corner, edge and surface of the dielectric resonance block; or a plurality of slots or holes are symmetrically formed in different corners, edges and surfaces of the dielectric resonance block; or a plurality of slots or holes are formed in the same surface of the dielectric resonance block; or a slot or hole is formed inside the dielectric resonance block; or slots or holes are symmetrically formed in different axial directions of the dielectric resonance block; or a plurality of slots or holes are formed in the same surface of the dielectric resonance block; or a protrusion is formed in the surface; or different numbers of protruding cylinders and protruding polygons are arranged at any position on any surface; the shape of the dielectric resonance bar or metal resonance bar is a cylinder, an ellipsoid, a cube, a cuboid, and a polygon; a resonator with a single axial direction or vertically intersecting resonators with single axial directions or three mutually vertically intersecting resonators with single axial directions are solid or hollow; materials of the dielectric resonance block and the dielectric resonance bar are ceramic, composite dielectric materials, and dielectric materials with a dielectric constant greater than 1; the dielectric surface may also be metalized; a material of the metal resonance bar is aluminum, copper, iron, and other metal materials; or the surface of the metal resonance bar is metalized again; and the resonators are in different shapes, are made of different materials, and have different dielectric constants, which will also affect the frequencies, Q values and numbers of the fundamental mode and the high-order modes or the high-order modes and higher-order modes.

In one preferable implementation solution of the present disclosure, the dielectric and/or metal supporting frames are located on the end surface, edge and sharp corner of the resonator or the sharp corner of the cavity and are arranged between the dielectric resonator and the cavity body; the resonator is supported by the supporting frame in the cavity body; the supporting frame and the resonator or the cavity are combined to form an integrated structure or a split type structure; the dielectric supporting frame is made of a dielectric material; the material of the dielectric supporting frame is air, plastic, ceramic, or a composite dielectric material; the metal supporting frame is made of aluminum, copper, silver, and other conductive materials; the dielectric and metal materials may also be combined to form a mixed material supporting frame; when the supporting frame is mounted at different positions of the resonator, the frequency span between the corresponding fundamental mode and high-order modes or the frequency span between the high-order modes and higher-order modes will also be different; and the materials and dielectric constants of different dielectric supporting frames and different structures will also affect the frequency span between the corresponding fundamental mode and high-order modes or the frequency span between the high-order modes and higher-order modes.

In one preferable implementation solution of the present disclosure, the supporting frame is connected to the resonator and the cavity in a manner of pressing, adhesion, splicing, welding, buckling, or screw connection; and the supporting frame is connected to one or more end surfaces of the resonator with the single axial direction or the vertically intersecting resonators with the single axial directions or the three mutually vertically intersecting resonators with the single axial directions.

In one preferable implementation solution of the present disclosure, the supporting frame is mounted at any position corresponding to the resonator and the inner wall of the cavity, is matched with any shape of the resonator and any shape of the cavity for connection and fixing; the supporting frame includes a solid with two parallel surfaces or a center-through structure; the number of the supporting frame at the same end surface or different end surfaces, edges, and sharp corners on the resonator is one or a plurality of different combinations; frequencies, number of modes and Q values corresponding to different numbers of supporting frames will also be different; and when the dimension of the inner wall of the cavity and the dimensions of the resonators corresponding to the three axial directions change or the dimensions in the horizontal and vertical directions change, the Q values of the fundamental mode and high-order modes will change for multiple times.

In one preferable implementation solution of the present disclosure, the supporting frame of the resonator and the inner wall of the cavity are in contact to achieve heat conduction.

The present disclosure provides a dielectric filter. A resonance unit with a single axial direction or two mutually vertically intersecting resonance units with single axial directions or three mutually vertically intersecting resonance units with single axial directions may be combined to form 1-N single-pass band filters with different frequencies. The single-pass band filters with different frequencies are combined to form any combination of a multi-pass band filter, a duplexer or a multiplexer; the corresponding resonance unit may be further subjected to any permutation and combination in different forms together with a metal or dielectric single-mode resonance cavity, double-mode resonance cavity or three-mode resonance cavity, so as to form a plurality of required single-pass band or multi-pass band filters or duplexers or multiplexers or any combinations in different dimensions.

In one preferable implementation solution of the present disclosure, any combination of adjacent coupling or cross coupling can be randomly performed with the cavities corresponding to the resonance unit with the single axial direction or the two mutually vertically intersecting resonance units with the single axial directions or the three mutually vertically intersecting resonance units with the single axial directions may be with the single-mode or multimode cavities of the metal resonator and the single-mode or multimode cavities of the resonator.

The embodiments of the present disclosure has the beneficial effects: in the embodiments of the present disclosure, the dielectric resonance block is provided with the through hole or the blind hole; the dielectric resonance bar or the metal resonance bar is put into the through hole and the blind hole to reduce the frequency, which effectively solves the relevant technical problems.

### BRIEF DESCRIPTION OF THE DRAWINGS

To describe the embodiments of the present disclosure or the technical solutions in the related art more clearly, drawings required to be used in the embodiments or the illustration of the related art will be briefly introduced below. Obviously, the drawings in the illustration below are some embodiments of the present disclosure. Those ordinarily skilled in the art also can acquire other drawings according to the provided drawings without doing creative work.

FIG. 1 to FIG. 6 are schematic structural diagrams of combination with a dielectric or metal resonance bar when a dielectric resonance block in a first implementation mode of a resonance unit of the present disclosure is provided with a blind hole;

FIG. 7 to FIG. 12 are schematic structural diagrams of combination with a dielectric or metal resonance bar when a dielectric resonance block in a first implementation mode of a resonance unit of the present disclosure is provided with a through hole;

FIG. 13 to FIG. 18 are schematic structural diagrams of combination between a dielectric resonance block in a first implementation mode of a resonance unit of the present disclosure and a dielectric or metal resonance bar;

FIG. 19 to FIG. 22 are schematic structural diagrams of a second implementation mode of a resonance unit of the present disclosure;

FIG. 23 to FIG. 24 are schematic structural diagrams of a third implementation mode of a resonance unit of the present disclosure;

FIG. 25 is a schematic structural diagram of a fourth implementation mode of a resonance unit of the present disclosure; and

FIG. 26 is a schematic structural diagram of a fifth implementation mode of a resonance unit of the present disclosure.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described herein are part of the embodiments of the present disclosure, not all the embodiments. Based on the embodiments in the present disclosure, all other embodiments obtained by those of ordinary skill in the art without doing creative work shall fall within the protection scope of the present disclosure.

In the description of the present disclosure, it should be understood that orientations or positional relationships indicated by the terms “length”, “width”, “upper”, “lower”, “front”, “rear”, “left”, “right”, “vertical”, “horizontal”, “top”, “bottom”, “inside”, “outside” and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are not construed as limiting the present disclosure.

In addition, the terms “first” and “second” are used for descriptive purposes only and are not to be understood to indicate or imply relative importance or to imply the number of indicated technical features. Therefore, features defined by “first” and “second” can explicitly instruct or impliedly include one or more features. In the description of the present disclosure, unless expressly specified otherwise, the meaning of the “plurality” is two or more than two.

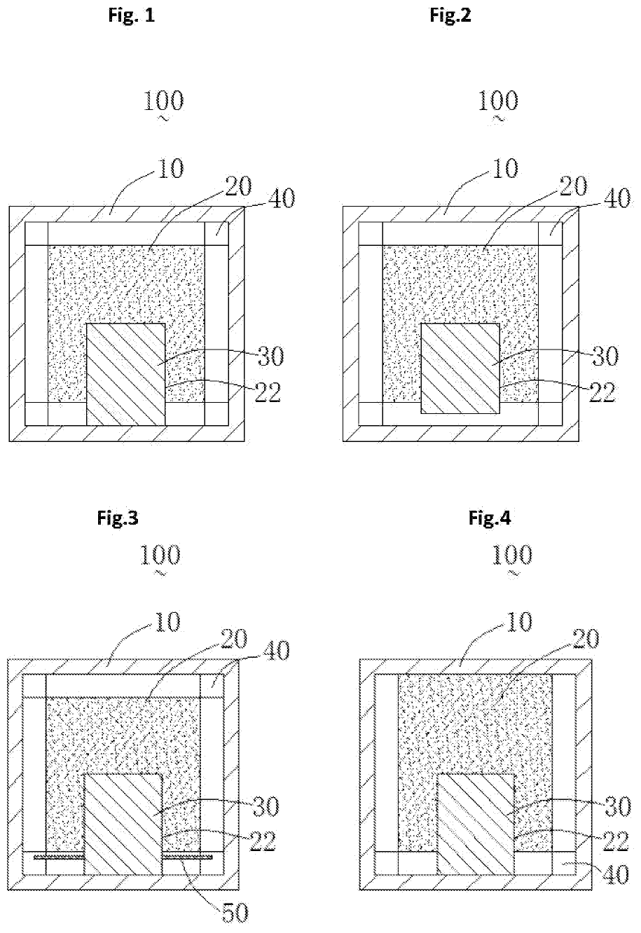

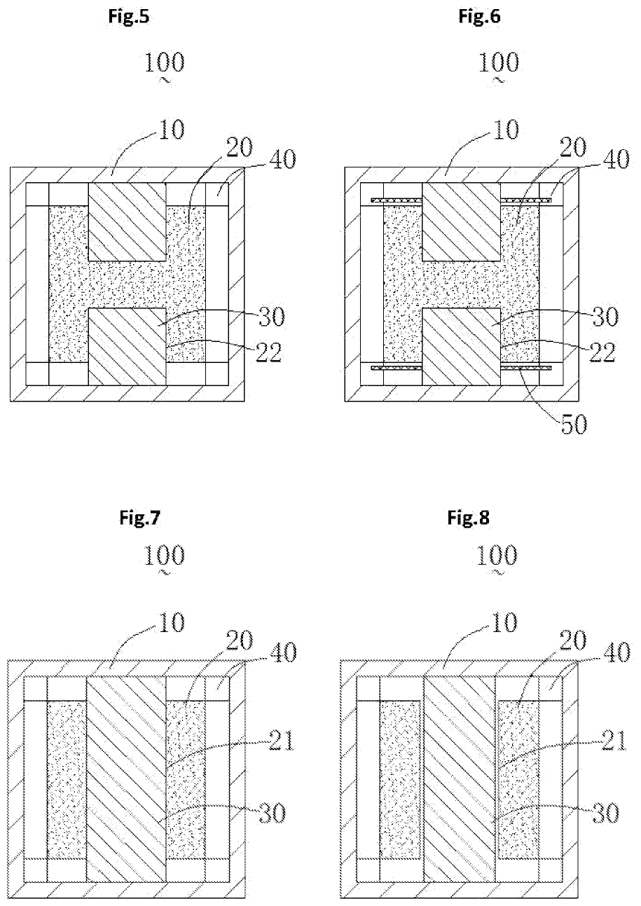

Referring to FIG. 1 to FIG. 26, a resonance unit 100 provided by an embodiment of the present disclosure includes a cavity 10, a supporting frame 40, a resonator (not shown), and a cover plate (not shown). The cavity 10 is a closed space. One surface of the cavity 10 is a cover plate surface. An inner surface of the cavity 10 is defined as an inner wall (not shown) of the cavity; and the inner wall of the cavity 10 is coated with a conductive layer. The resonator is composed of a dielectric resonance block 20 and a resonance bar 30. The resonance bar 30 is a metal resonance bar or a dielectric resonance bar. The resonator is mounted in the cavity 10. The supporting frame 40 is mounted at any position between the resonator and the inner wall of the cavity 10 and is matched with any shape of the resonator and the cavity 10 for connection and fixing.

When one axial direction of the dielectric resonance block 20 in the resonator is a through hole 21, the dielectric resonance block 20 is mounted in the cavity 10 and is in no contact with the inner wall of the cavity. The metal resonance bar or the dielectric resonance bar is mounted in the through hole 21 of the dielectric resonance block 20.

One end of the dielectric resonance block 20 is in contact with the inner wall of the cavity. The metal resonance bar or the dielectric resonance bar is mounted in the through hole 21 of the dielectric resonance block 20. One end of the resonance bar 30 is in contact with the inner wall of the cavity or is in no contact with the inner wall of the cavity and is suspended. If one end is not in contact with the inner wall of the cavity, a flange plate 50 may be disposed according to an actual need. A surface of the flange plate 50 of the dielectric resonance bar may be coated with a metal layer for metalization. Of course, two ends of the metal resonance bar or the dielectric resonance bar in the same axial direction may also be simultaneously in contact with the inner wall of the cavity. The resonance bar 30 and the resonance block are combined to form an integrated resonator. Any vertical axial direction of the dielectric resonance block 20 is combined with the metal resonance bar or the dielectric resonance bar to achieve a resonance structure with a single axial direction.

Or, two ends of the dielectric resonance block 20 in the same axial direction are both in contact with the inner wall of the cavity. The metal resonance bar or the dielectric resonance bar is mounted in the through hole 21 of the dielectric resonance block 20. One end of the resonance bar 30 is in contact with the inner wall of the cavity or is in no contact with the inner wall of the cavity and is suspended. If one end is not in contact with the inner wall of the cavity, a flange plate 50 may be disposed according to an actual need. A surface of the flange plate 50 of the dielectric resonance bar may be coated with a metal layer for metalization. Of course, two ends of the metal resonance bar or the dielectric resonance bar in the same axial direction may also be simultaneously in contact with the inner wall of the cavity. The resonance bar 30 and the resonance block are combined to form an integrated resonator. Any vertical axial direction of the dielectric resonance block 20 is combined with the metal resonance bar or the dielectric resonance bar to achieve a resonance structure with a single axial direction.

When one axial direction of the dielectric resonance block 20 in the resonator is provided with a blind hole 22, the dielectric resonance block 20 is mounted in the cavity 10. When the resonance block is in no contact with the inner wall of the cavity, one end of the metal resonance bar or the dielectric resonance bar is mounted in the blind hole 22, and the other end is in contact with the inner wall of the cavity. Of course, one end of the metal resonance bar or the dielectric resonance bar is mounted in the blind hole 22, and the other end is not in contact with the inner wall of the cavity. A flange plate 50 may be disposed at this end which is not in contact with the inner wall of the cavity according to an actual need. A surface of the flange plate 50 of the dielectric resonance bar may be coated with a metal layer for metalization, so as to form an integrated resonator.

When one end of the dielectric resonance block 20 is in contact with the inner wall of the cavity, one end of the metal resonance bar or the dielectric resonance bar is mounted in the blind hole 22, and the other end is in contact with the inner wall of the cavity. Of course, one end of the metal resonance bar or the dielectric resonance bar is mounted in the blind hole 22, and the other end is not in contact with the inner wall of the cavity. A flange plate 50 may be disposed at this end which is not in contact with the inner wall of the cavity according to an actual need. A surface of the flange plate 50 of the dielectric resonance bar may be coated with a metal layer for metalization, so as to form an integrated resonator.

Or, when two ends of the dielectric resonance block 20 in the same axial direction are in contact with the inner wall of the cavity, one end of the metal resonance bar or the dielectric resonance bar is mounted in the blind hole 22, and the other end is in contact with the inner wall of the cavity. Of course, one end of the metal resonance bar or the dielectric resonance bar is mounted in the blind hole 22, and the other end is not in contact with the inner wall of the cavity. A flange plate 50 may be disposed at this end which is not in contact with the inner wall of the cavity according to an actual need. A surface of the flange plate 50 of the dielectric resonance bar may be coated with a metal layer for metalization, so as to form an integrated resonator.

The dielectric resonance block 20 in the resonator is solid or one axial direction is a blind hole 22, one end of the metal resonance bar in the same axial direction is mounted on a surface of the dielectric resonance block 20 or in the blind hole 22, the other end is in contact with the inner wall of the cavity; the metal resonance bar is mounted on a surface corresponding to the same axial direction of the dielectric resonance block 20 or is mounted on surfaces corresponding to different axial directions of the dielectric resonance block 20, or one or more metal resonance bars are mounted on different axial surfaces of the dielectric resonance block 20 or in the blind hole 22, so as to form an integrated resonator; and any vertical axial direction of the dielectric resonance block 20 is combined with the metal resonance bar or the dielectric resonance bar to achieve a resonance structure with a single axial direction.

One cylindrical or polygonal resonator with a single axial direction and a fixed supporting frame 40 thereof are arranged in the cavity 10 to form a single-mode or multi-mode resonance unit 100 together with the cavity 10. Or, two vertically intersecting cylindrical or polygonal resonators with single axial directions and a fixed supporting frame 40 thereof are arranged in the cavity 10 to form a single-mode or multi-mode resonance unit 100 together with the cavity 10. The X-axial dimension of the cylindrical or polygonal resonator in the X-axis direction is greater than or equal to the perpendicular dimension, parallel to the X-axial direction, of the cylindrical or polygonal resonator with a Y axis. The Y-axial dimension of the cylindrical or polygonal resonator in the Y-axis direction is greater than or equal to the perpendicular dimension, parallel to the Y-axial direction, of the cylindrical or polygonal resonator with an X axis. Or, three mutually vertically intersecting cylindrical or polygonal resonators with single axial directions and a fixed supporting frame 40 thereof are arranged in the cavity 10, so as to form a single-mode or multi-mode resonance unit 100 together with the cavity 10. The X-axial dimension of the cylindrical or polygonal resonator in the X-axis direction is greater than or equal to the perpendicular dimensions, parallel to the X-axial direction, of the cylindrical or polygonal resonator with a Y axis and the cylindrical or polygonal resonator with a Z axis. The Y-axial dimension of the cylindrical or polygonal resonator in the Y-axis direction is greater than or equal to the perpendicular dimensions, parallel to the Y-axial direction, of the cylindrical or polygonal resonator with an X axis and the cylindrical or polygonal resonator with the Z axis. The Z-axial dimension of the cylindrical or polygonal resonator in the Z-axis direction is greater than or equal to the perpendicular dimensions, parallel to the Z-axial direction, of the cylindrical or polygonal resonator with the X axis and the cylindrical or polygonal resonator with the Y axis. When the resonance unit 100 is a resonator with a single axial direction, vertically intersecting resonators with single axial directions, or three mutually vertically intersecting resonators with single axial directions, the resonator is subjected to edge cutting, slotting, and corner cutting in horizontal and vertical directions, so that the dimension of the inner wall of the cavity and the dimensions of the resonators corresponding to three axial directions change or the dimensions in the horizontal and vertical directions change, so as to change frequency of a fundamental mode and the frequency of a plurality of high-order modes, the number of corresponding multimodes, and Q values. When the resonance unit 100 is vertically intersecting resonators with single axial directions or three mutually vertically intersecting resonators with single axial directions, and when the dimension of the cylindrical or polygonal resonator in any one axial direction is less than the perpendicular dimensions, parallel to the axial direction, of the cylindrical or polygonal resonators in the other one or two axial directions, the frequency and Q values of the corresponding fundamental mode and plurality of high-order modes will correspondingly change. When the frequency of the fundamental mode remains unchanged, the resonance unit 100 is composed of the resonators with different dielectric constants, the cavity 10 and the supporting frame 40. The single modes, the multimodes and the Q values corresponding to the frequencies of the fundamental mode and the plurality of high-order modes will change. The Q values of the resonators with different dielectric constants change differently, and the frequencies of the high-order modes will also change.

A resonance unit 100 with a single axial direction or two mutually vertically intersecting resonance units 100 with single axial directions or three mutually vertically intersecting resonance units 100 with single axial directions are provided. One axial direction of the dielectric resonance block 20 in the resonator is a through hole 21, the dielectric resonance block 20 is mounted in the cavity 10 and is in no contact with the inner wall of the cavity. The metal resonance bar is mounted in the through hole 21 of the dielectric resonance block 20.

One end of the dielectric resonance block 20 is in contact with the inner wall of the cavity. The metal resonance bar is mounted in the through hole 21 of the dielectric resonance block 20. One end of the resonance bar 30 is in contact with the inner wall of the cavity or is not in contact with the inner wall and is suspended. If one end is not in contact with the inner wall of the cavity, a flange plate 50 may be disposed according to an actual need. Of course, two ends of the metal resonance bar in the same axial direction may be simultaneously in contact with the inner wall of the cavity. The resonance bar 30 and the resonance block are combined to form an integrated resonator. Any vertical axial direction of the dielectric resonance block 20 is combined with the metal resonance bar to achieve a resonance structure with a single axial direction.

Or, two ends of the dielectric resonance block 20 in the same axial direction are in contact with the inner wall of the cavity. The metal resonance bar is mounted in the through hole 21 of the dielectric resonance block 20. One end of the resonance bar 30 is in contact with the inner wall of the cavity or is not in contact with the inner wall and is suspended. If one end is not in contact with the inner wall of the cavity, a flange plate 50 may be disposed according to an actual need. Of course, two ends of the metal resonance bar in the same axial direction may be simultaneously in contact with the inner wall of the cavity. The resonance bar 30 and the resonance block are combined to form an integrated resonator. Any vertical axial direction of the dielectric resonance block 20 is combined with the metal resonance bar or the dielectric resonance bar to achieve a resonance structure with a single axial direction.

When one axial direction of the dielectric resonance block 20 in the resonator is provided with a blind hole 22, the dielectric resonance block 20 is mounted in the cavity 10. When the resonance block is in no contact with the inner wall of the cavity, one end of the metal resonance bar is mounted in the blind hole 22, and the other end is in contact with the inner wall of the cavity. Of course, one end of the metal resonance bar or the dielectric resonance bar is mounted in the blind hole 22, and the other end is not in contact with the inner wall of the cavity. A flange plate 50 may be disposed at this end according to an actual need, so as to form an integrated resonator.

When one end of the dielectric resonance block 20 is in contact with the inner wall of the cavity, one end of the metal resonance bar is mounted in the blind hole 22, and the other end is in contact with the inner wall of the cavity. Of course, one end of the metal resonance bar is mounted in the blind hole 22, and the other end is not in contact with the inner wall of the cavity. A flange plate 50 may be disposed at this end which is not in contact with the inner wall of the cavity according to an actual need, so as to form an integrated resonator.

Or, when two ends of the dielectric resonance block 20 in the same axial direction are in contact with the inner wall of the cavity, one end of the metal resonance bar is mounted in the blind hole 22, and the other end is in contact with the inner wall of the cavity. Of course, one end of the metal resonance bar is mounted in the blind hole 22, and the other end is not in contact with the inner wall of the cavity. A flange plate 50 may be disposed at this end is not in contact with the inner wall of the cavity according to an actual need, so as to form an integrated resonator.

When the dielectric resonance block 20 in the resonator is solid or one axial direction is a blind hole 22, one end of the metal resonance bar in the same axial direction is mounted on a surface of the dielectric resonance block 20 or in the blind hole 22, and the other end is in contact with the inner wall of the cavity. The metal resonance bar is mounted on one or two surfaces corresponding to the same axial direction of the dielectric resonance block 20 or is mounted on surfaces corresponding to different axial directions of the dielectric resonance block 20; or one or more metal resonance bars are mounted on different axial surfaces of the dielectric resonance block 20 or in the blind hole 22, so as to form an integrated resonator. Any vertical axial direction of the dielectric resonance block 20 is combined with the metal resonance bar to achieve a resonance structure with a single axial direction, a vertically intersecting double-axis resonance structure or a mutually vertically intersecting three-axis resonance structure. A frequency corresponding to the axial direction of the metal resonance bar decreases. The flange plate 50 at one end of the metal resonance bar further reduces the frequency. The decrease of the frequency when the metal resonance bar in the through hole 21 of the dielectric resonance block 20 is completely fitted to the inner wall of the through hole 21 is greater than the decrease of the frequency when there is a gap.

A resonance unit 100 with a single axial direction or two mutually vertically intersecting resonance units 100 with single axial directions or three mutually vertically intersecting resonance units 100 with single axial directions are provided. One axial direction of the dielectric resonance block 20 in the resonator is a through hole 21, the dielectric resonance block 20 is mounted in the cavity 10 and is in no contact with the inner wall of the cavity. The dielectric resonance bar is mounted in the through hole 21 of the dielectric resonance block 20.

One end of the dielectric resonance block 20 is in contact with the inner wall of the cavity. The dielectric resonance bar is mounted in the through hole 21 of the dielectric resonance block 20. One end of the resonance bar 30 is in contact with the inner wall of the cavity or is in no contact with the inner wall of the cavity and is suspended. If one end is not in contact with the inner wall of the cavity, a flange plate 50 may be disposed according to an actual need. A surface of the flange plate 50 of the dielectric resonance bar may be coated with a metal layer for metalization. Of course, two ends of the dielectric resonance bar in the same axial direction may also be simultaneously in contact with the inner wall of the cavity. The resonance bar 30 and the resonance block are combined to form an integrated resonator. Any vertical axial direction of the dielectric resonance block 20 is combined with the dielectric resonance bar to achieve a resonance structure with a single axial direction.

Or, two ends of the dielectric resonance block 20 in the same axial direction are in contact with the inner wall of the cavity. The dielectric resonance bar is mounted in the through hole 21 of the dielectric resonance block 20. One end of the resonance bar 30 is in contact with the inner wall of the cavity or is not in contact with the inner wall and is suspended. If one end is not in contact with the inner wall of the cavity, a flange plate 50 may be disposed according to an actual need. A surface of the flange plate 50 of the dielectric resonance bar may be coated with a metal layer for metalization. Of course, two ends of the dielectric resonance bar in the same axial direction may be simultaneously in contact with the inner wall of the cavity. The resonance bar 30 and the resonance block are combined to form an integrated resonator. Any vertical axial direction of the dielectric resonance block 20 is combined with the metal resonance bar or the dielectric resonance bar to achieve a resonance structure with a single axial direction.

When one axial direction of the dielectric resonance block 20 in the resonator is provided with a blind hole 22, the dielectric resonance block 20 is mounted in the cavity 10. When the resonance block is in no contact with the inner wall of the cavity, one end of the dielectric resonance bar is mounted in the blind hole 22, and the other end is in contact with the inner wall of the cavity. Of course, one end of the dielectric resonance bar is mounted in the blind hole 22, and the other end is not in contact with the inner wall of the cavity. A flange plate 50 may be disposed at this end which is not in contact with the inner wall of the cavity according to an actual need. A surface of the flange plate 50 of the dielectric resonance bar may be coated with a metal layer for metalization, so as to form an integrated resonator.

When one end of the dielectric resonance block 20 is in contact with the inner wall of the cavity, one end of the dielectric resonance bar is mounted in the blind hole 22, and the other end is in contact with the inner wall of the cavity. Of course, one end of the dielectric resonance bar is mounted in the blind hole 22, and the other end is not in contact with the inner wall of the cavity. A flange plate 50 may be disposed at this end which is not in contact with the inner wall of the cavity according to an actual need. A surface of the flange plate 50 of the dielectric resonance bar may be coated with a metal layer for metalization, so as to form an integrated resonator.

Or, when two ends of the dielectric resonance block 20 in the same axial direction are in contact with the inner wall of the cavity, one end of the dielectric resonance bar is mounted in the blind hole 22, and the other end is in contact with the inner wall of the cavity. Of course, one end of the dielectric resonance bar is mounted in the blind hole 22, and the other end is not in contact with the inner wall of the cavity. A flange plate 50 may be disposed at this end which is not in contact with the inner wall of the cavity according to an actual need. A surface of the flange plate 50 of the dielectric resonance bar may be coated with a metal layer for metalization, so as to form an integrated resonator.

When the dielectric resonance block 20 in the resonator is solid or one axial direction is a blind hole 22, one end of the dielectric resonance bar in the same axial direction is mounted on a surface of the dielectric resonance block 20 or in the blind hole 22, and the other end is in contact with the inner wall of the cavity. The dielectric resonance bar is mounted on a surface corresponding to the same axial direction of the dielectric resonance block 20 or is mounted on surfaces corresponding to different axial directions of the dielectric resonance block 20; or one or more dielectric resonance bars are mounted on different axial surfaces of the dielectric resonance block 20 or in the blind hole 22, so as to form an integrated resonator. Any vertical axial direction of the dielectric resonance block 20 is combined with the dielectric resonance bar to achieve a resonance structure with a single axial direction, a vertically intersecting double-axis resonance structure or a mutually vertically intersecting three-axis resonance structure. A frequency corresponding to the axial direction decreases, when the end surface of the dielectric resonance bar is grounded. The flange plate 50 at one end of the dielectric resonance bar further reduces the frequency. The decrease of the frequency when the metal resonance bar in the blind hole 22 of the dielectric resonance block 20 is completely fitted to the inner wall of the blind hole 22 is greater than the decrease of the frequency when there is a gap.

A resonance unit 100 with a single axial direction or two mutually vertically intersecting resonance units 100 with single axial directions or three mutually vertically intersecting resonance units 100 with single axial directions are provided. When one axial direction of the dielectric resonance block 20 in the resonator is a blind hole 22, the dielectric resonance block 20 is mounted in the cavity 10 and is in contact with the inner wall of the cavity, or one end of the dielectric resonance block 20 is in contact with the inner wall of the cavity, or two ends of the dielectric resonance block 20 in the same axial direction are in contact with the inner wall of the cavity; the metal resonance bar is mounted in the blind hole 22; one end is in contact with the inner wall of the cavity, and the other end is provided with a flange plate 50, so as to form an integrated resonator; or the metal resonance bar is mounted in the blind hole 22, and two ends are neither in contact with the inner wall of the cavity, so as to combine an integrated dielectric resonator and metal resonator; a gap is reserved between the metal resonance bar and the inner wall of the blind hole 22 of the dielectric resonance block 20, or the metal resonance bar is fitted to the inner wall of the blind hole 22; the metal resonance bar is mounted in different axial directions of the dielectric resonance block 20, or is a single-axis, vertically intersecting double-axis or mutually vertically intersecting three-axis metal resonance bar; a frequency corresponding to an axial direction of the metal resonance bar decreases; the flange plate 50 at one end of the metal resonance bar further reduces the frequency; and the decrease of the frequency when the metal resonance bar in the blind hole 22 of the dielectric resonance block 20 is completely fitted to the inner wall of the blind hole 22 is greater than the decrease of the frequency when there is a gap.

A resonance unit 100 with a single axial direction or two mutually vertically intersecting resonance units 100 with single axial directions or three mutually vertically intersecting resonance units 100 with single axial directions are provided. When one axial direction of the dielectric resonance block 20 in the resonator is a blind hole 22, the dielectric resonance block 20 is mounted in the cavity 10 and is in no contact with the inner wall of the cavity, or one end of the dielectric resonance block 20 is in contact with the inner wall of the cavity, or two ends of the dielectric resonance block 20 in the same axial direction are in contact with the inner wall of the cavity; the dielectric resonance bar is mounted in the blind hole 22; one end or two ends corresponding to the axial direction is in contact with the inner wall of the cavity, so as to form an integrated resonator; or the dielectric resonance bar is mounted in the blind hole 22 of the dielectric resonance block 20, and the dielectric resonance bar is in no contact with the inner wall of the cavity, so as to combine an integrated dielectric and metal resonator; a gap is reserved between the dielectric resonance bar and the inner wall of the blind hole 22 of the dielectric resonance block 20, or the dielectric resonance bar is completely fitted to the inner wall of the blind hole 22; the dielectric resonance bar is mounted in any axial direction of the dielectric resonance block 20 or is a single-axis, vertically intersecting double-axis or mutually vertically intersecting three-axis dielectric resonance bar; a frequency corresponding to an axial direction decreases when the end surface of the dielectric resonance bar is grounded; and the decrease of the frequency when the dielectric resonance bar in the blind hole 22 of the dielectric resonance block 20 is completely fitted to the inner wall of the blind hole 22 is greater than the decrease of the frequency when there is a gap.

A resonance unit 100 with a single axial direction or two mutually vertically intersecting resonance units 100 with single axial directions or three mutually vertically intersecting resonance units 100 with single axial directions are provided. When the dielectric resonance block 20 in the resonator is solid or one axial direction is a blind hole 22, one end of the metal resonance bar in the same axial direction is mounted on a surface of the dielectric resonance block 20 or in the blind hole 22, and the other end is in contact with the inner wall of the cavity; the metal resonance bar is mounted on a surface corresponding to the same axial direction of the dielectric resonance block 20 or is mounted on surfaces corresponding to different axial directions of the dielectric resonance bar; or one or more metal resonance bars are mounted on different axial surfaces of the dielectric resonance block 20 or in the blind hole 22, so as to form an integrated resonator; the dielectric resonance bar is mounted in any axial direction of the dielectric resonance block 20, or is a single-axis, vertically intersecting double-axis or mutually vertically intersecting three-axis dielectric resonance bar; and a frequency corresponding to the axial direction decreases when the end surface of the dielectric resonance bar is grounded.

One cylindrical or polygonal resonator with a single axial direction and a fixed supporting frame 40 thereof are arranged in the cavity 10 to form a single-mode or multi-mode dielectric resonance structure together with the cavity 10. The center of the end surface of the resonator is close to or overlaps the center position of an inner wall surface corresponding to the cavity 10; the resonator is subjected to edge cutting, slotting, and corner cutting in horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of a plurality of high-order modes, the number of corresponding multimodes and Q values. When the X, Y, and Z-axial dimensions of the inner wall of the cavity change, the X, Y, and Z-axial dimensions of the resonator corresponding to the inner wall of the cavity will also correspondingly change while maintaining at least one required frequency unchanged.

Two vertically intersecting cylindrical or polygonal resonators with single axial directions and a fixed supporting frame 40 thereof are arranged in the cavity 10, so as to form a single-mode or multi-mode dielectric resonance structure together with the cavity 10, and the center of the end surface of the resonator is close to or overlaps the center position of an inner wall surface corresponding to the cavity 10. The X-axial dimension of the cylindrical or polygonal resonator in the X-axis direction is greater than or equal to the perpendicular dimension, parallel to the X-axial direction, of the cylindrical or polygonal resonator with a Y axis. The Y-axial dimension of the cylindrical or polygonal resonator in the Y-axis direction is greater than or equal to the perpendicular dimension, parallel to the Y-axial direction, of the cylindrical or polygonal resonator with an X axis. The resonator is subjected to edge cutting, slotting, and corner cutting in the horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of a plurality of high-order modes, the number of corresponding multimodes and Q values. When the X, Y, and Z-axial dimensions of the inner wall of the cavity change, the X, Y, and Z-axial dimensions of the resonator corresponding to the inner wall of the cavity will also correspondingly change while maintaining one required frequency unchanged.

Three mutually vertically intersecting cylindrical or polygonal resonators with single axial directions and a fixed supporting frame 40 thereof are arranged in the cavity 10, so as to form a single-mode or multi-mode dielectric resonance structure together with the cavity 10, and the center of the end surface of the resonator is close to or overlaps the center position of an inner wall surface corresponding to the cavity 10. The X-axial dimension of the cylindrical or polygonal resonator in the X-axis direction is greater than or equal to the perpendicular dimensions, parallel to the X-axial direction, of the cylindrical or polygonal resonator with a Y axis and the cylindrical or polygonal resonator with a Z axis. The Y-axial dimension of the cylindrical or polygonal resonator with a Y-axial direction is greater than or equal to the perpendicular dimensions, parallel to the Y-axial direction, of the cylindrical or polygonal resonator with the X axis and the cylindrical or polygonal resonator with the Z axis. The Z-axial dimension of the cylindrical or polygonal resonator in the Z-axis direction is greater than or equal to the perpendicular dimensions, parallel to the Z-axial direction, of the cylindrical or polygonal resonator with the X axis and the cylindrical or polygonal resonator with the Y axis. The resonator is subjected to edge cutting, slotting, and corner cutting in the horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of a plurality of high-order modes, the number of corresponding multimodes and Q values. When the X, Y, and Z-axial dimensions of the inner wall of the cavity change, the X, Y, and Z-axial dimensions of the resonator corresponding to the inner wall of the cavity will also correspondingly change while maintaining one required frequency unchanged.

A resonance unit 100 with a single axial direction or two mutually vertically intersecting resonance units 100 with single axial directions or three mutually vertically intersecting resonance units 100 with single axial directions are provided. When the dimensions of one axial resonator in the resonators and the other one or two axial resonators or the dimensions of the three axial resonators and the dimensions of the corresponding cavities change, the numbers and frequencies of the corresponding fundamental mode and multimodes and the Q values will also correspondingly change; the decrease of the frequency when the metal and the dielectric resonance bars in the through hole 21 of the dielectric resonance block 20 are completely fitted is to the inner wall of the through hole 21 greater than the decrease of the frequency when there is a gap; when the end surfaces of the metal and dielectric resonance bars are in contact with the inner wall of the cavity, the frequency decreases; after the flange plate 50 is added on the end surfaces of the metal resonance bar and the dielectric resonance bar, the frequency is further reduced; and if the flange plate 50 has a larger area, the frequency decreases more.

A resonance unit 100 with a single axial direction or two mutually vertically intersecting resonance units 100 with single axial directions or three mutually vertically intersecting resonance units 100 with single axial directions are provided. When the dimension of the inner wall of the cavity and the dimensions of the resonators corresponding to three axial directions change or the dimensions in the horizontal and vertical directions change, the multimodes and Q values corresponding to the fundamental mode and the plurality of high-order modes will change. Frequencies and Q values corresponding to resonators with different dielectric constants change differently.

A resonance unit 100 with a single axial direction or two mutually vertically intersecting resonance units 100 with single axial directions or three mutually vertically intersecting resonance units 100 with single axial directions are provided. When the dimension of the inner wall of the cavity and the dimensions of the resonators corresponding to the three axial directions change or the dimensions in the horizontal and vertical directions change, while the frequency of the fundamental mode remains unchanged, spans between the frequency of the high-order modes and the frequency of the fundamental mode as well as spans between the frequency of the high-order modes change differently; spans between the frequency of the resonators with different dielectric constants change differently; when the dimensions of the cavities corresponding to the dimensions of one axial resonator and the other one or two axial resonators or the dimensions of the three axial resonators change, the spans between the frequency of the corresponding fundamental mode and the frequency of the multimodes will also correspondingly change.

A resonance unit 100 with a single axial direction or two mutually vertically intersecting resonance units 100 with single axial directions or three mutually vertically intersecting resonance units 100 with single axial directions are provided. When the dimension of the inner wall of the cavity and the dimensions of the resonators corresponding to the three axial directions change or the dimensions in the horizontal and vertical directions change, while the dimension of the cavity 10 and the frequency of the fundamental mode remain unchanged, the fundamental mode and the high-order modes of the resonance unit 100 may form at least one multimode with the same frequency or with close frequencies; when the dimensions of the cavities corresponding to the dimensions of one axial resonator and the other one or two axial resonators or the dimensions of the three axial resonators change, the number of the corresponding fundamental mode and the number of the corresponding multimodes will also correspondingly change.

The resonator or cavity 10 is cut at structural position perpendicular to an electric field or magnetic field or an edge is added, so as to form an adjacent coupling, and the cavity 10 and the resonator are cut into triangles or quadrangles; or the edge of the cavity 10 or the resonator is partially or overall cut off or added; the cavity 10 and the resonator are simultaneously or separately subjected to edge cutting; after the adjacent coupling is formed by edge cutting, the frequencies and the Q values will correspondingly change; the adjacent coupling is changed into intersecting coupling; intersecting structural positions of three resonance axial electric fields or magnetic fields formed by intersecting three surfaces of the cavities 10 corresponding to the single axial resonator and the other one or two axial resonators are subjected to corner cutting or supplementation or are subjected to corner cutting and supplementation and closed with the corresponding cavities 10 to form the intersecting coupling, and the corresponding frequencies and Q values will also correspondingly change; at the same time, the adjacent coupling is changed; and when the corners and edges of the resonators are slotted or perforated or protrude, the strength of the adjacent coupling and the strength of the intersecting coupling are changed. At least one tuning device is arranged at a position with concentrated field strength of the resonator.

A resonance unit 100 with a single axial direction or two mutually vertically intersecting resonance units 100 with single axial directions or three mutually vertically intersecting resonance units 100 with single axial directions are provided. The shape of the corresponding cavity 10 includes, but is not limited to, a cuboid, a cube, and a polygon; the surface of the inner wall of the cavity or part of an internal region may be set to be a recess or a protrusion or a cut corner or a slot; at least one tuning device is arranged at a position with concentrated field strength of the dielectric resonator and is mounted on the cavity 10; a material of the cavity 10 is metal or non-metal; the surface of the cavity is electroplated with copper or silver. The cavities 10 in different shapes will affect the Q values, the frequencies, and the number of modes

Shapes combined by the cross sections of a resonance unit 100 with a single axial direction or two mutually vertically intersecting resonance units 100 with single axial directions or three mutually vertically intersecting resonance units 100 with single axial directions and a vertical axial direction include at least one of the following: a cylinder, an ellipsoid, a cube, a cuboid, and a polygon. The dielectric resonance block 20 is provided with a through hole 21 and a blind hole 22, and slots or holes are formed in the corner, edge and surface of the dielectric resonance block; or a plurality of slots or holes are symmetrically formed in different corners, edges and surfaces of the dielectric resonance block; or a plurality of slots or holes are formed in the same surface of the dielectric resonance block; or a slot or hole is formed inside the dielectric resonance block; or slots or holes are symmetrically formed in different axial directions of the dielectric resonance block; or a plurality of slots or holes are formed in the same surface of the dielectric resonance block; or a protrusion is formed in the surface; or different numbers of protruding cylinders and protruding polygons are arranged at any position on any surface. The shape of the dielectric or metal resonance bar is a cylinder, an ellipsoid, a cube, a cuboid, and a polygon. The resonance structure is set to be solid or hollow. The resonator with the single axial direction or the vertically intersecting resonators with the single axial directions or the three mutually vertically intersecting resonators with the single axial directions are solid or hollow. Materials of the dielectric resonance block 20 and the dielectric resonance bar are ceramic, composite dielectric materials, and dielectric materials with a dielectric constant greater than 1. A material of the metal resonance bar is aluminum, copper, iron, and other metal materials. A surface of a plastic or ceramic material is metalized, or a surface of the metal resonance bar is metalized again. The resonators are in different shapes, are made of different materials, and have different dielectric constants, which will also affect the frequency, Q value and number of the fundamental mode and the high-order modes or the high-order modes and higher-order modes.

The dielectric and/or metal supporting frames 40 are located on the end surface, edge and sharp corner of the resonator or the sharp corner of the cavity and are arranged between the dielectric resonator and the cavity body; and the resonator is supported by the supporting frame 40 in the cavity body. The supporting frame 40 and the resonator or the cavity 10 are combined to form an integrated structure or a split type structure. The dielectric supporting frame 40 is made of a dielectric material. The material of the dielectric supporting frame 40 is air, plastic, ceramic, or a composite dielectric material. The metal supporting frame 40 is made of aluminum, copper, silver, and other conductive materials. The dielectric and metal materials may also be combined to form a mixed material supporting frame 40. When the supporting frame 40 is mounted at different positions of the resonator, the frequency span between the corresponding fundamental mode and high-order modes or the frequency span between the high-order modes and higher-order modes will also be different. The materials and dielectric constants of different dielectric supporting frames 40 and different structures will also affect the frequency span between the corresponding fundamental mode and high-order modes or the frequency span between the high-order modes and higher-order modes.

The supporting frame 40 is connected to the resonator and the cavity 10 in a manner of pressing, adhesion, splicing, welding, buckling, or screw connection; and the supporting frame 40 is connected to one or more end surfaces of the resonator with the single axial direction or the vertically intersecting resonators with the single axial directions or the three mutually vertically intersecting resonators with the single axial directions.

The supporting frame 40 is mounted at any position on the inner wall of the cavity 10 and the resonator, is matched with any shape of the resonator and any shape of the cavity 10 for connection and fixing; the supporting frame 40 includes a solid with two parallel surfaces or a center-through structure; the number of the supporting frame 40 at the same end surface or different end surfaces, edges, and sharp corners is a combination of one or more; frequency, number of modes and Q values corresponding to different numbers of supporting frames 40 will also be different; and when the dimension of the inner wall of the cavity and the dimensions of the resonators corresponding to the three axial directions change or the dimensions in the horizontal and vertical directions change, the Q values of the fundamental mode and high-order modes will change for multiple times. The supporting frame 40 of the resonator and the inner wall of the cavity 10 are in contact to achieve heat conduction.

An embodiment of the present disclosure provides a dielectric filter. A resonance unit 100 with a single axial direction or two mutually vertically intersecting resonance units 100 with single axial directions or three mutually vertically intersecting resonance units 100 with single axial directions may be combined to form 1-N single-pass band filters with different frequencies. The single-pass band filters with different frequencies are combined to form any combination of a multi-pass band filter, a duplexer or a multiplexer; the corresponding resonance unit 100 may be further subjected to any permutation and combination in different forms together with a metal or dielectric single-mode resonance cavity 10, double-mode resonance cavity 10 or three-mode resonance cavity 10, so as to form a plurality of required single-pass band or multi-pass band filters or duplexers or multiplexers or any combinations in different dimensions.

Cavities 10 corresponding to the resonance unit 100 with the single axial direction or the two mutually vertically intersecting resonance units 100 with the single axial directions or the three mutually vertically intersecting resonance units 100 with the single axial directions may be randomly combined with the single-mode or multimode cavities 10 of the metal resonator and the single-mode or multimode cavities 10 of the resonator, so as to form adjacent coupling intersecting coupling.

Detailed descriptions will be made below in combination with simulation experiment data.

In order to accurately show the technical characteristics of the embodiment of the present disclosure, experimental data obtained from a simulation experiment done with a conventional dielectric resonance unit is compared with the experimental data obtained from a simulation experiment in the embodiment of the present invention, as follows: It is set that the cavity of the dielectric resonance unit is a 30 mm cuboid; the dielectric resonance block is a 25 mm cuboid; and a solved frequency is 500 MHz. By means of simulation and calculation of the above characteristics, it is concluded that the dimension combination can achieve that a fundamental mode of a resonator with a single axial direction is a single-mode characteristic, and a simulated frequency (MHz) is: 2.06819.

The following is simulation experimental data of the embodiment of the present disclosure.

In the simulation experiment I, when the resonance bar 30 is a dielectric resonance bar, and the blind hole 22 is formed on the dielectric resonance block 20, parameters and relations of the various components are set as follows:
the cavity 10 of the resonance unit 100 is a 30 mm cuboid;
the dielectric resonance block 20 is a 25 mm cuboid; the solved frequency is 500 MHZ; and a dielectric constant of the dielectric resonance block 20 is Er34.5_1/36600;
the dielectric constant of the dielectric resonance bar is Er45_1/43000;
a diameter of the blind hole 22 provided on the dielectric resonator block 20 is 10 mm;
when the dielectric resonance bar and the blind hole 22 are fitted together, the diameter of the dielectric resonance bar is 10 mm; and when the gap between the dielectric resonance bar and the blind hole 22 is 0.1 mm, the diameter of the dielectric resonance bar is 9.8 mm.

If the dielectric resonance bar is provided with a flange plate 50, a diameter of the flange plate 50 is 20 mm.

By means of the simulation calculation of the above characteristics, it is concluded that this dimension combination can realize the fundamental mode of the resonator with the single axial direction is a single-mode characteristic, and simulation results are as follows: (The following table shows relations between a resonance bar that is a dielectric resonance bar of a dielectric and metal combined resonance unit and all structures. ●: indicating an existing state. Space: indicating a non-existing state.)

Dielectric resonance bar

| Relation with the | | Gap relation with | | | | |
|---|---|---|---|---|---|---|
| inner wall of the cavity | | the blind hole | | Flange plate | | |
| Contact | Not Contact | There is a gap | Fitted | Yes | No | Frequency(MHz) |
| ● | | ● | | ● | | 1.67529 |
| ● | | ● | | | ● | 1.68813 |
| ● | | | ● | ● | | 1.63277 |
| ● | | | ● | | ● | 1.64256 |
| | ● | ● | | ● | | 1.92684 |
| | ● | ● | | | ● | 1.97136 |
| | ● | | ● | ● | | 1.88343 |
| | ● | | ● | | ● | 1.92100 |

In the simulation experiment II, when the resonance bar 30 is a metal resonance bar, and the blind hole 22 is formed on the dielectric resonance block 20, parameters and relations of the various components are set as follows:
the cavity 10 of the resonance unit 100 is a 30 mm cuboid;
the dielectric resonance block 20 is a 25 mm cuboid; the solved frequency is 500 MHZ; and a dielectric constant of the dielectric resonance block 20 is Er34.5_1/36600;
a diameter of the blind hole 22 provided on the dielectric resonator block 20 is 10 mm;
when the metal resonance bar and the blind hole 22 are fitted together, the diameter of the metal resonance bar is 10 mm; and when the gap between the metal resonance bar and the blind hole 22 is 0.1 mm, the diameter of the metal resonance bar is 9.8 mm.

If the metal resonance bar is provided with a flange plate 50, a diameter of the flange plate 50 is 20 mm.

By means of the simulation calculation of the above characteristics, it is concluded that this dimension combination can realize the fundamental mode of the resonator with the single axial direction is a single-mode characteristic, and simulation results are as follows: (The following table shows relations between a resonance bar that is a metal resonance bar of a dielectric and metal combined resonance unit and all structures. ●: indicating an existing state. Space: indicating a non-existing state.)

Metal resonance bar

| Relation with the inner | | Gap relation with | | | | |
|---|---|---|---|---|---|---|
| wall of the cavity | | the blind hole | | Flange plate | | |
| Contact | Not contact | There is a gap | Fitted | Yes | No | Frequency(MHz) |
| ● | | ● | | ● | | 1.05248 |
| ● | | ● | | | ● | 1.03303 |
| ● | | | ● | ● | | 0.917714 |
| ● | | | ● | | ● | 0.904707 |
| | ● | ● | | ● | | 1.47422 |
| | ● | ● | | | ● | 1.69334 |
| | ● | | ● | ● | | 1.28709 |
| | ● | | ● | | ● | 1.41943 |

In the simulation experiment III, when the resonance bar 30 is a dielectric resonance bar, and the through hole 21 is formed on the dielectric resonance block 20, parameters and relations of the various components are set as follows:
the cavity 10 of the resonance unit 100 is a 30 mm cuboid;
the dielectric resonance block 20 is a 25 mm cuboid; the solved frequency is 500 MHz; and a dielectric constant of the dielectric resonance block 20 is Er34.5_1/36600;
the dielectric constant of the dielectric resonance bar is Er45_1/43000;
a diameter of the through hole 21 provided on the dielectric resonator block 20 is 10 mm;
when the dielectric resonance bar and the through hole 21 are fitted together, the diameter of the dielectric resonance bar is 10 mm; and when the gap between the dielectric resonance bar and the through hole 21 is 0.1 mm, the diameter of the dielectric resonance bar is 9.8 mm.

If the dielectric resonance bar is provided with a flange plate 50, a diameter of the flange plate 50 is 20 mm.

By means of the simulation calculation of the above characteristics, it is concluded that this dimension combination can realize the fundamental mode of the resonator with the single axial direction is a single-mode characteristic, and simulation results are as follows: (The following table shows relations between a resonance bar that is a dielectric resonance bar of a dielectric and metal combined resonance unit and all structures. ●: indicating an existing state, space: indicating a non-existing state.)

Dielectric resonance bar

| Relation with the inner | | | Gap relation with | | | | |
|---|---|---|---|---|---|---|---|
| wall of the cavity | | | the through hole | | | | |
| Contact with | Conatct with | Not | There is | | Flange plate | | Frequency |
| one end | two ends | conatct | a gap | Fitted | Yes | No | (MHz) |
| ● | | | ● | | ● | | 1.60499 |
| ● | | | ● | | | ● | 1.65456 |
| ● | | | | ● | ● | | 1.57573 |
| ● | | | | ● | | ● | 1.62393 |
| | ● | | ● | | ● | | 1.41472 |
| | ● | | ● | | | ● | 1.42641 |
| | ● | | | ● | ● | | 1.37420 |
| | ● | | | ● | | ● | 1.38464 |
| | | ● | ● | | ● | | 1.89354 |
| | | ● | ● | | | ● | 1.96600 |
| | | ● | | ● | ● | | 1.87017 |
| | | ● | | ● | | ● | 1.93315 |

In the simulation experiment IV, when the resonance bar 30 is a metal resonance bar, and the through hole 21 is formed on the dielectric resonance block 20, parameters and relations of the various components are set as follows:
the cavity 10 of the resonance unit 100 is a 30 mm cuboid;
the dielectric resonance block 20 is a 25 mm cuboid; the solved frequency is 500 MHz; and a dielectric constant of the dielectric resonance block 20 is Er34.5_1/36600;
a diameter of the through hole 21 provided on the dielectric resonator block 20 is 10 mm;
when the metal resonance bar and the through hole 21 are fitted together, the diameter of the metal resonance bar is 10 mm; and when the gap between the metal resonance bar and the through hole 21 is 0.1 mm, the diameter of the metal resonance bar is 9.8 mm.

If the metal resonance bar is provided with a flange plate 50, a diameter of the flange plate 50 is 20 mm.

By means of the simulation calculation of the above characteristics, it is concluded that this dimension combination can realize the fundamental mode of the resonator with the single axial direction is a single-mode characteristic, and simulation results are as follows: (The following table shows relations between a resonance bar that is a metal resonance bar of a dielectric and metal combined resonance unit and all structures. ●: indicating an existing state. Space: indicating a non-existing state.)

Metal resonance bar

| Relation with the inner | | | Gap relation with | | | | |
|---|---|---|---|---|---|---|---|
| wall of the cavity | | | the through hole | | | | |
| Contact with | Contact with | Not | There is | | Flange plate | | Frequency |
| one end | two ends | contact | a gap | Fitted | Yes | No | (MHz) |
| ● | | | ● | | ● | | 0.713841 |
| ● | | | ● | | | ● | 0.866418 |
| ● | | | | ● | ● | | 0.691439 |
| ● | | | | ● | | ● | 0.801626 |
| | | ● | ● | | ● | | 1.24558 |
| | | ● | ● | | | ● | 1.43344 |
| | | ● | | ● | ● | | 1.14144 |
| | | ● | | ● | | ● | 1.25426 |

Before the above simulation experiments, the related structures are also simulated. The structures are as follows: a 30 mm cuboid single cavity, a 25 mm dielectric cuboid, a solved frequency of 500 MHZ, and a dielectric block of Er34.5_1/36600. The simulated result frequency is 2.06819 GHZ.

From the above simulation experimental data, it can be known that in the resonance unit 100, the dielectric resonance block 20 is set to be hollow or solid, and inserting a metal resonance bar or a dielectric resonance bar into the dielectric resonance block 20 can effectively reduce the frequency. It can be seen from the above simulation experiment mathematics that in the resonance unit 100 provided by the embodiment of the present disclosure, the amplitude of frequency reduction of the metal resonance bar is greater than amplitude of frequency reduction of the dielectric resonance bar. The amplitude of frequency reduction when the dielectric resonance bar or the metal resonance bar is in contact with the inner wall of the cavity is greater than the amplitude of frequency reduction when the metal resonance bar is in no contact with the inner wall of the cavity. The amplitude of frequency reduction when the dielectric resonance bar or the metal resonance bar is in close fit with the blind hole or through hole provided on the dielectric resonance block is greater than the amplitude of frequency reduction when there is a gap between the dielectric resonance bar or the metal resonance bar and the blind hole or through hole provided on the dielectric resonance block; the amplitude of frequency reduction when the dielectric resonance bar or the metal resonance bar is in contact with the blind hole 22 or the through hole 21 of the resonance block is greater than the amplitude of frequency reduction when the dielectric resonance bar or the metal resonance bar is in no contact with the blind hole 22 or the through hole 21 of the resonance block; and the amplitude of frequency reduction when the dielectric resonance bar or the metal resonance bar is provided with the flange plate 50 is greater than the amplitude of frequency reduction when the dielectric resonance bar or the metal resonance bar is not provided with the flange plate 50. In addition, it can be known from the above rules that when the dielectric resonance block 20 is in contact with the inner wall of the cavity, the amplitude of frequency reduction is greater than the amplitude of frequency reduction when the dielectric resonance block 20 is in no contact with the inner wall of the cavity. When the flange plate 50 is made of metal or a surface is plated with metal, the amplitude of frequency reduction is greater than the amplitude of frequency reduction when the flange plate 50 is made of a dielectric material.

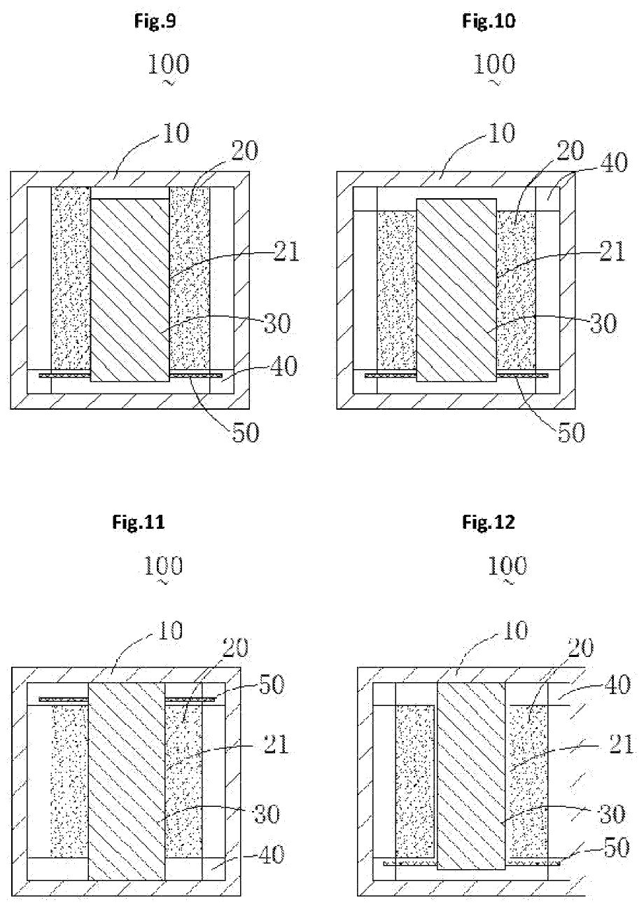

As shown in FIG. 13 to FIG. 18, the dielectric resonance block 20 of the resonance unit 100 provided by the embodiment of the present disclosure is not provided with a through hole or blind hole for accommodating the dielectric or metal resonance bar. The dielectric or metal resonance bar is placed on a surface of the dielectric resonance block 20. A through hole or blind hole can still be provided on the dielectric resonance block 20, but the through hole or blind hole does not have a structural matching relationship with the dielectric or metal resonance bar. Of course, the dielectric or metal resonance bar may or may not be in contact with the inner wall of the cavity, and the flange plate 50 may also be provided on the end of the dielectric or metal resonance bar according to the actual needs to assist the dielectric or metal resonance bar to increase the amplitude of frequency reduction. This implementation mode has the same rule for reducing the frequency as the through hole or blind hole of the dielectric or metal resonance bar described above, and will not be repeated here.

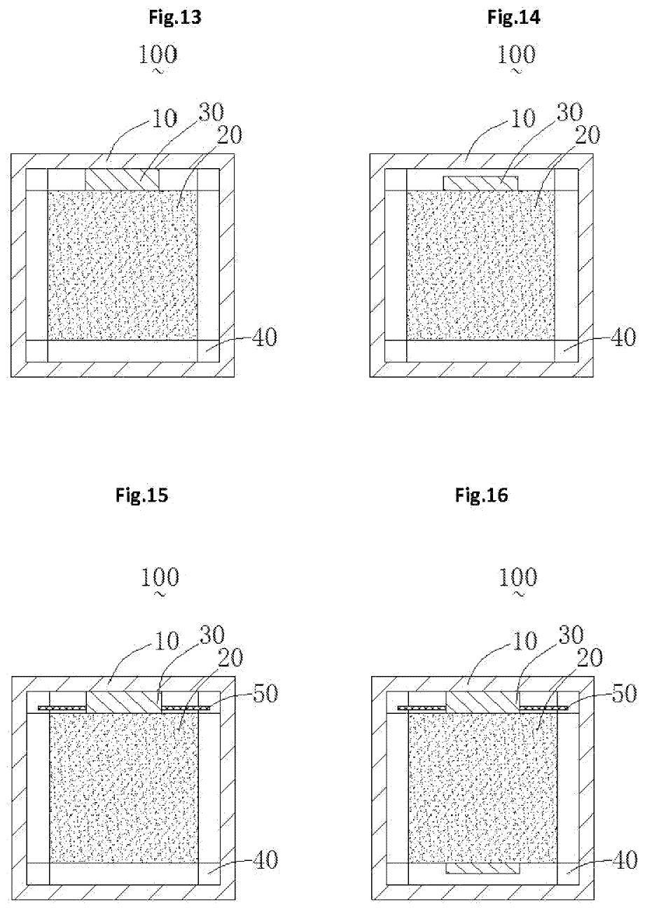

As shown in FIG. 19 to FIG. 22, in the second implementation mode of the present disclosure: two or more surfaces of the dielectric resonance block 20 of the resonance unit 100 cooperate with dielectric or metal resonance bar to better achieve an effect of reducing the frequency. The rule for reducing the frequency by providing the blind hole or through hole in the position, cooperating with the dielectric or metal resonance bar, on the dielectric resonance block 20 or by providing no region for accommodating the dielectric or metal resonance bar is the same as the above-mentioned rule for reducing the frequency in a manner of cooperation between the dielectric resonance block and the dielectric or metal resonance bar, and will not be repeated here.

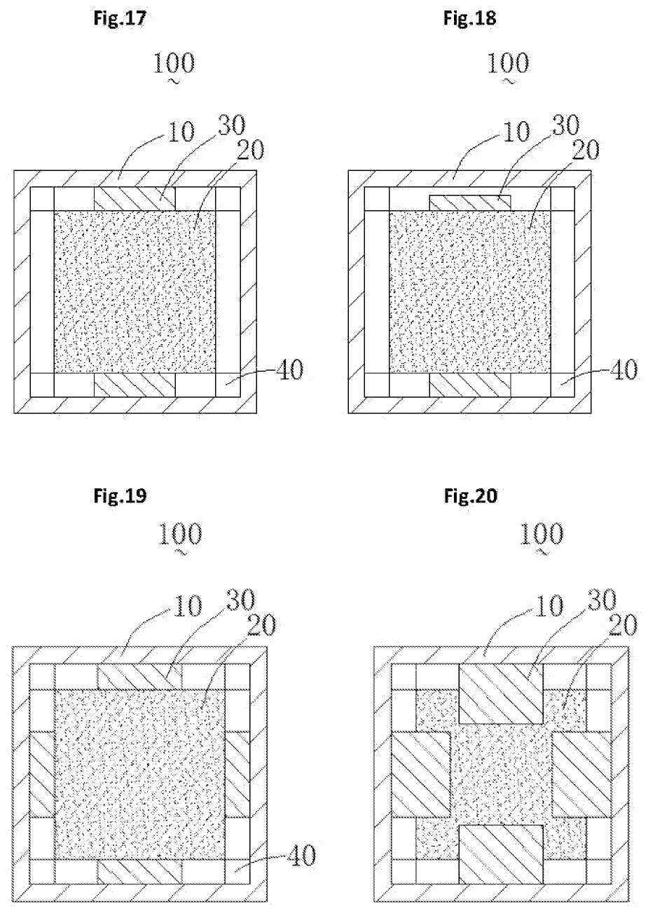

As shown in FIG. 23 to FIG. 24, in the third implementation mode of the present disclosure, when the dielectric resonance block 20 of the resonance unit 100 is two vertically intersecting cylinders or polygons, the rule of reducing frequency amplitude in cooperation with the dielectric or metal resonance bar is the same as the rule of reducing frequency amplitude in a manner of cooperation between dielectric resonance block 20 with the single axial direction and the dielectric or metal resonance bar, and will not be repeated here.

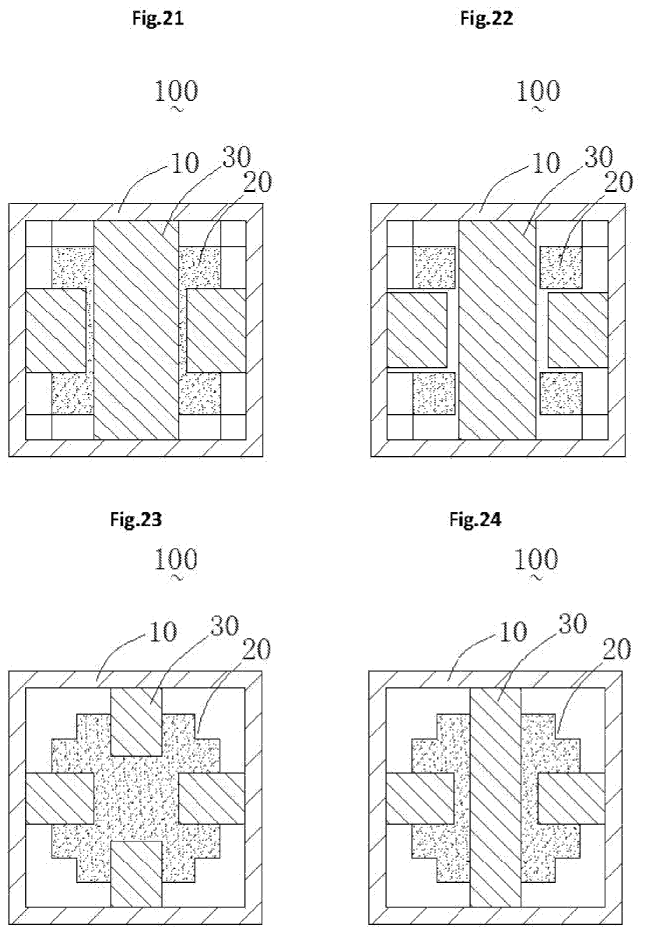

As shown in FIG. 25, in the fourth implementation mode of the present disclosure, each surface in the dielectric resonance block 20 of the resonance unit 100 cooperates with the dielectric or metal resonance bar, which can better achieve the effect of reducing the frequency, and the rule for reducing the frequency amplitude is the same as that in the foregoing implementation mode and will not be repeated here.

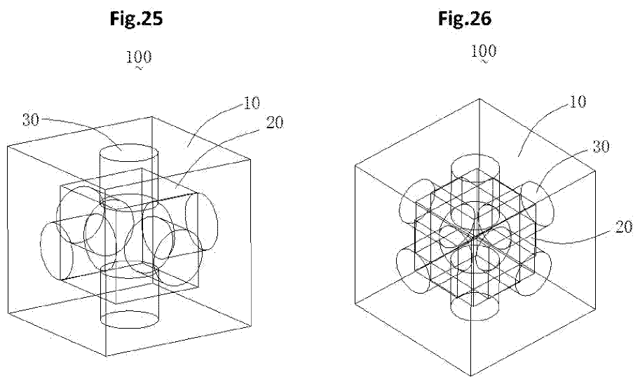

As shown in FIG. 26, in the fifth implementation mode of the present disclosure, when the dielectric resonance block 20 of the resonance unit 100 is three mutually vertically intersecting cylinders or polygons, the rule for reducing the frequency amplitude in cooperation with the dielectric or metal resonance bar is the same as the rule for reducing the frequency amplitude in a manner of cooperation between dielectric resonance block 20 with the single axial direction and the dielectric or metal resonance bar, and will not be repeated here.

The device embodiments described above are only illustrative, and the units described as separate components may or may not be physically separated, and the components displayed as units may or may not be physical units, that is, they may be located in one place, or may be distributed to multiple network units. Some or all of the modules may be selected according to actual needs to achieve the objectives of the solutions of the embodiments. Those of ordinary skill in the art can understand and implement the objectives without creative work.

It should be finally noted that: the above embodiments are only used to describe the technical solutions of the present disclosure, and not intended to limit the present disclosure. Although the present disclosure has been described in detail with reference to the foregoing embodiments, those ordinarily skilled in the art should understand that they can still modify the technical solutions described in all the foregoing embodiments, or equivalently replace some of the technical features, and these modifications or replacements do not depart the essences of the corresponding technical solutions from the spirit and scope of the technical solutions of all the embodiments of the present disclosure.

### Industrial Practicability

A dielectric resonance unit provided by an embodiment of the present disclosure includes a cavity, a supporting frame, a resonator, and a cover plate. The cavity is a sealed space. One surface of the cavity is a cover plate surface; the resonator is composed of a dielectric resonance block and a resonance bar; the resonator is mounted in the cavity; and the supporting frame is mounted at any position between the resonator and an inner wall of the cavity and is matched with any shape of the resonator and the cavity for connection and fixing. At least one hole for accommodating the resonance bar is provided on the dielectric resonance block. The resonance bar and the dielectric resonance block are non-electrically connected. In the embodiments of the present disclosure, the dielectric resonance block is provided with a through hole or a blind hole; a dielectric resonance bar or a metal resonance bar is put into the through hole and the blind hole to reduce the frequency, which effectively solves the relevant technical problems.

What is claimed is:

1. A resonance unit, comprising a cavity, a supporting frame, a resonator, and a cover plate, wherein the cavity is a sealed space; one surface of the cavity is a cover plate surface; the resonator is composed of a dielectric resonance block and a resonance bar; the resonator is mounted in the cavity; the supporting frame is mounted at any position between the resonator and an inner wall of the cavity and is matched with any shape of the resonator and the cavity for connection and fixing;
when one axial direction of the dielectric resonance block in the resonator is a through hole, the dielectric resonance block is mounted in the cavity and is in no contact with the inner wall of the cavity; or, one end of the dielectric resonance block is in contact with the inner wall of the cavity; or, two ends of the dielectric resonance block in the same axial direction are in contact with the inner wall of the cavity; a metal resonance bar or a dielectric resonance bar is mounted in the through hole of the dielectric resonance block; one end is in contact or in no contact with the inner wall of the cavity, and the other end is in no contact with the inner wall of the cavity, and/or the end which is in no contact with the inner wall of the cavity is provided with a flange plate; a surface of the flange plate of the dielectric resonance bar is metalized; two ends of the dielectric resonance bar in the same axial direction are in contact with the inner wall of the cavity to form an integrated resonator; any vertical axial direction of the dielectric resonance block and the metal resonance bar or the dielectric resonance bar are combined to achieve a resonance structure with a single axial direction;
when one axial direction of the dielectric resonance block in the resonator is a blind hole, the dielectric resonance block is mounted in the cavity and is in no contact with the inner wall of the cavity; or, one end of the dielectric resonance block is in contact with the inner wall of the cavity; or, two ends of the dielectric resonance block in the same axial direction are in contact with the inner wall of the cavity; one end of a metal resonance bar or a dielectric resonance bar is mounted in the blind hole; the other end is in contact with the inner wall of the cavity or is not in contact with the inner wall of the cavity, and/or the end which is not in contact with the inner wall of the cavity is provided with a flange plate to form an integrated resonator; any vertical axial direction of the dielectric resonance block and the metal resonance bar or the dielectric resonance bar are combined to achieve a resonance structure with a single axial direction;
when the dielectric resonance block in the resonator is solid or one axial direction is a blind hole, one end of the metal resonance bar in the same axial direction is mounted on a surface of the dielectric resonance block or in the blind hole; the other end is in contact with the inner wall of the cavity; a metal resonance bar is mounted on one or two surfaces corresponding to the same axial direction of the dielectric resonance block, or is mounted on surfaces corresponding to different axial directions of the dielectric resonance block, or one or more metal resonance bars are mounted on different axial surfaces of the dielectric resonance block or in the blind hole to form an integrated resonator; any vertical axial direction of the dielectric resonance block and the metal resonance bar or the dielectric resonance bar are combined to achieve a resonance structure with a single axial direction;
one cylindrical or polygonal resonator with a single axial direction and a fixed supporting frame thereof are arranged in the cavity, so as to form a single-mode or multi-mode resonance unit together with the cavity; or
two vertically intersecting cylindrical or polygonal resonators with single axial directions and a fixed supporting frame thereof are arranged in the cavity, so as to form a single-mode or multi-mode resonance unit together with the cavity; the X-axial dimension of the cylindrical or polygonal resonator in the X-axial direction is greater than or equal to the perpendicular dimension, parallel to the X-axial direction, of the cylindrical or polygonal resonator with a Y axis; the Y-axial dimension of the cylindrical or polygonal resonator in the Y-axial direction is greater than or equal to the perpendicular dimension, parallel to the Y-axial direction, of the cylindrical or polygonal resonator with an X axis; or
three mutually vertically intersecting cylindrical or polygonal resonators with single axial directions and a fixed supporting frame thereof are arranged in the cavity, so as to form a single-mode or multi-mode resonance unit together with the cavity; the X-axial dimension of the cylindrical or polygonal resonator in the X-axial direction is greater than or equal to the perpendicular dimensions, parallel to the X-axial direction, of the cylindrical or polygonal resonator with a Y axis and the cylindrical or polygonal resonator with a Z axis; the Y-axial dimension of the cylindrical or polygonal resonator in the Y-axis direction is greater than or equal to the perpendicular dimensions, parallel to the Y-axial direction, of the cylindrical or polygonal resonator with an X axis and the cylindrical or polygonal resonator with the Z axis; the Z-axial dimension of the cylindrical or polygonal resonator in the Z-axis direction is greater than or equal to the perpendicular dimensions, parallel to the Z-axial direction, of the cylindrical or polygonal resonator with the X axis and the cylindrical or polygonal resonator with the Y axis;
when the resonance unit is a resonator with a single axial direction, vertically intersecting resonators with single axial directions, or three mutually vertically intersecting resonators with single axial directions, the resonator is subjected to edge cutting, slotting, and corner cutting in horizontal and vertical directions, so that the dimension of the inner wall of the cavity and the dimensions of the resonators corresponding to three axial directions change or the dimensions in the horizontal and vertical directions change, so as to change frequency of a fundamental mode and the frequency of a plurality of high-order modes, the number of corresponding multimodes and Q values;
when the resonance unit is vertically intersecting resonators with single axial directions or three mutually vertically intersecting resonators with single axial directions, and when the dimension of the cylindrical or polygonal resonator in any one axial direction is less than the perpendicular dimensions, parallel to the axial direction, of the cylindrical or polygonal resonators in the other one or two axial directions, the frequencies and Q values of the fundamental mode and the plurality of high-order modes corresponding to the resonators will correspondingly change;
when the frequency of the fundamental mode remains unchanged, the resonance unit is composed of the resonators with different dielectric constants, the cavity and the supporting frame; the single modes, the multimodes and the Q values corresponding to the frequencies of the fundamental mode and the plurality of high-order modes will change; the Q values of the resonators with different dielectric constants change differently; and the frequencies of the high-order modes will also change.

2. The resonance unit according to claim 1, wherein a resonance unit with a single axial direction or two mutually vertically intersecting resonance units with single axial directions or three mutually vertically intersecting resonance units with single axial directions are provided; when one axial direction of the dielectric resonance block in the resonator is a through hole, the dielectric resonance block is mounted in the cavity and is in no contact with the inner wall of the cavity, or one end of the dielectric resonance block is in contact with the inner wall of the cavity, or two ends of the dielectric resonance block in the same axial direction are in contact with the inner wall of the cavity; the metal resonance bar is mounted in the through hole; one end is in contact with the inner wall of the cavity, and the other end which is in no contact with the inner wall is provided with a flange plate, so as to form an integrated resonator; or the metal resonance bar is mounted in the through hole, and two ends are in no contact with the inner wall of the cavity, so as to combine an integrated dielectric and metal resonator; a gap is reserved between the metal resonance bar and the inner wall of the through hole of the dielectric resonance block, or the metal resonance bar is completely fitted to the inner wall of the through hole; the metal resonance bar may be mounted in different axial directions of the dielectric resonance block and may be a single-axis, vertically intersecting double-axis or mutually vertically intersecting three-axis metal resonance bar; a frequency corresponding to an axial direction of the metal resonance bar decreases; the flange plate at one end of the metal resonance bar further reduces the frequency; and the decrease of the frequency when the metal resonance bar in the through hole of the dielectric resonance block is completely fitted to the inner wall of the through hole is greater than the decrease of the frequency when there is a gap.

3. The resonance unit according to claim 1, wherein a resonance unit with a single axial direction or two mutually vertically intersecting resonance units with single axial directions or three mutually vertically intersecting resonance units with single axial directions are provided; when one axial direction of the dielectric resonance block in the resonator is a through hole, the dielectric resonance block is mounted in the cavity and is in no contact with the inner wall of the cavity, or one end of the dielectric resonance block is in contact with the inner wall of the cavity, or two ends of the dielectric resonance block in the same axial direction are in contact with the inner wall of the cavity; the dielectric resonance bar is mounted in the through hole; one end or two ends corresponding to the axial direction is in contact with the inner wall of the cavity; when one end corresponding to the axial direction is in contact with the inner wall, the other end is in no contact with the inner wall, and a surface-metalized dielectric flange plate is added on the end surface of the end, so as to form an integrated resonator; or the dielectric resonance bar is mounted in the through hole of the dielectric resonance block, and two ends of the dielectric resonance bar are in no contact with the inner wall of the cavity, so as to combine an integrated dielectric and metal resonator; a gap is reserved between the inner wall of the through hole of the dielectric resonance block and the dielectric resonance bar, or the metal resonance bar is completely fitted to the inner wall of the through hole; the dielectric resonance bar is mounted in any axial direction of the dielectric resonance block or may be a single-axis, vertically intersecting double-axis or mutually vertically intersecting three-axis dielectric resonance bar; a frequency corresponding to an axial direction when the end surface of the dielectric resonance bar is in contact with the inner wall decreases; the metallization of the flange plate at one end of the dielectric resonance bar further reduces the frequency; and the decrease of the frequency when the metal resonance bar in the through hole of the dielectric resonance block is completely fitted to the inner wall of the through hole is greater than the decrease of the frequency when there is a gap.

4. The resonance unit according to claim 1, wherein a resonance unit with a single axial direction or two mutually vertically intersecting resonance units with single axial directions or three mutually vertically intersecting resonance units with single axial directions are provided; when one axial direction of the dielectric resonance block in the resonator is a blind hole, the dielectric resonance block is mounted in the cavity and is in contact with the inner wall of the cavity, or one end of the dielectric resonance block is in contact with the inner wall of the cavity, or two ends of the dielectric resonance block in the same axial direction are in contact with the inner wall of the cavity; the metal resonance bar is mounted in the blind hole; one end is in contact with the inner wall of the cavity, and the other end is provided with a flange plate, so as to form an integrated resonator; or the metal resonance bar is mounted in the blind hole, and two ends are both in no contact with the inner wall of the cavity, so as to combine an integrated dielectric and metal resonator; a gap is reserved between the metal resonance bar and the inner wall of the blind hole of the dielectric resonance block, or the metal resonance bar is fitted to the inner wall of the blind hole; the metal resonance bar is mounted in different axial directions of the dielectric resonance block, or is a single-axis, vertically intersecting double-axis or mutually vertically intersecting three-axis metal resonance bar; a frequency corresponding to an axial direction of the metal resonance bar decreases; the flange plate at one end of the metal resonance bar further reduces the frequency; and the decrease of the frequency when the metal resonance bar in the blind hole of the dielectric resonance block is completely fitted to the inner wall of the blind hole is greater than the decrease of the frequency when there is a gap.

5. The resonance unit according to claim 1, wherein a resonance unit with a single axial direction or two mutually vertically intersecting resonance units with single axial directions or three mutually vertically intersecting resonance units with single axial directions are provided; when one axial direction of the dielectric resonance block in the resonator is a blind hole, the dielectric resonance block is mounted in the cavity and is in no contact with the inner wall of the cavity, or one end of the dielectric resonance block is in contact with the inner wall of the cavity, or two ends of the dielectric resonance block in the same axial direction are in contact with the inner wall of the cavity; the metal resonance bar is mounted in the blind hole; one end or two ends corresponding to the axial direction is in contact with the inner wall of the cavity, so as to form an integrated resonator; or the dielectric resonance bar is mounted in the blind hole of the dielectric resonance block, and the dielectric resonance bar is in no contact with the inner wall of the cavity, so as to combine an integrated resonator; a gap is reserved between the dielectric resonance bar and the inner wall of the blind hole of the dielectric resonance block, or the dielectric resonance bar is completely fitted to the inner wall of the blind hole; the dielectric resonance bar is mounted in any axial direction of the dielectric resonance block or is a single-axis, vertically intersecting double-axis or mutually vertically intersecting three-axis dielectric resonance bar; a frequency corresponding to an axial direction decreases when the end surface of the dielectric resonance bar is grounded; and the decrease of the frequency when the dielectric resonance bar in the blind hole of the dielectric resonance block is completely fitted to the inner wall of the blind hole is greater than the decrease of the frequency when there is a gap.

6. The resonance unit according to claim 1, wherein a resonance unit with a single axial direction or two mutually vertically intersecting resonance units with single axial directions or three mutually vertically intersecting resonance units with single axial directions are provided; when the dielectric resonance block in the resonator is solid or one axial direction is a blind hole, one end of the metal resonance bar in the same axial direction is mounted on a surface of the dielectric resonance block or in the blind hole, and the other end is in contact with the inner wall of the cavity; or the metal resonance bar is mounted on a surface corresponding to the same axial direction of the dielectric resonance block or is mounted on surfaces corresponding to different axial directions of the dielectric resonance bar; or one or more metal resonance bars are mounted on different axial surfaces of the dielectric resonance block or in the blind hole, so as to form an integrated resonator; the dielectric resonance bar is mounted in any axial direction of the dielectric resonance block, or is a single-axis, vertically intersecting double-axis or mutually vertically intersecting three-axis dielectric resonance bar; and a frequency corresponding to an axial direction of the dielectric resonance block decreases, when a dielectric resonance bar is in contact with the dielectric resonance block on the axial direction surface.

7. The resonance unit according to claim 1, wherein one cylindrical or polygonal resonator with a single axial direction and a fixed supporting frame thereof are arranged in the cavity to form a single-mode or multi-mode dielectric resonance structure together with the cavity; the center of the end surface of the resonator is close to or overlaps the center position of an inner wall surface corresponding to the cavity; the resonator is subjected to edge cutting, slotting, and corner cutting in horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of multiple high-order modes, the number of corresponding multimodes and Q values; when the X, Y, and Z-axial dimensions of the inner wall of the cavity change, the X, Y, and Z-axial dimensions of the resonator corresponding to the inner wall of the cavity will also correspondingly change while maintaining at least one required frequency unchanged;
two vertically intersecting cylindrical or polygonal resonators with single axial directions and a fixed supporting frame thereof are arranged in the cavity, so as to form a single-mode or multi-mode dielectric resonance structure together with the cavity, and the center of the end surface of the resonator is close to or overlaps the center position of an inner wall surface corresponding to the cavity; the X-axial dimension of the cylindrical or polygonal resonator in the X-axis direction is greater than or equal to the perpendicular dimension, parallel to the X-axial direction, of the cylindrical or polygonal resonator with a Y axis; the Y-axial dimension of the cylindrical or polygonal resonator in the Y-axis direction is greater than or equal to the perpendicular dimension, parallel to the Y-axial direction, of the cylindrical or polygonal resonator with an X axis; the resonator is trimmed, slotted and chamfered in the horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of multiple high-order modes, the number of corresponding multimodes and Q values; when the X, Y, and Z-axial dimensions of the inner wall of the cavity change, the X, Y, and Z-axial dimensions of the resonator corresponding to the inner wall of the cavity will also correspondingly change while maintaining one required frequency unchanged;
three mutually vertically intersecting cylindrical or polygonal resonators with single axial directions and a fixed supporting frame thereof are arranged in the cavity, so as to form a single-mode or multi-mode dielectric resonance structure together with the cavity, and the center of the end surface of the resonator is close to or overlaps the center position of an inner wall surface corresponding to the cavity; the X-axial dimension of the cylindrical or polygonal resonator in the X-axis direction is greater than or equal to the perpendicular dimensions, parallel to the X-axial direction, of the cylindrical or polygonal resonator with a Y axis and the cylindrical or polygonal resonator with a Z axis; the Y-axial dimension of the cylindrical or polygonal resonator in the Y-axis direction is greater than or equal to the perpendicular dimensions, parallel to the Y-axial direction, of the cylindrical or polygonal resonator with the X axis and the cylindrical or polygonal resonator with the Z axis; the Z-axial dimension of the cylindrical or polygonal resonator in the X-axis direction is greater than or equal to the perpendicular dimensions, parallel to the Z-axial direction, of the cylindrical or polygonal resonator with the X axis and the cylindrical or polygonal resonator with the Y axis; the resonator is subjected to edge cutting, slotting, and corner cutting in the horizontal and vertical directions, so that the dimension of the inner wall of the cavity and the dimensions of the resonators corresponding to three axial directions change or the dimensions in the horizontal and vertical directions change, so as to change the frequency of a fundamental mode and the frequency of multiple high-order modes, the number of corresponding multimodes and Q values; when the X, Y, and Z-axial dimensions of the inner wall of the cavity change, the X, Y, and Z-axial dimensions of the resonator corresponding to the inner wall of the cavity will also correspondingly change while maintaining one required frequency unchanged.

8. The resonance unit according to claim 1, wherein a resonance unit with a single axial direction or two mutually vertically intersecting resonance units with single axial directions or three mutually vertically intersecting resonance units with single axial directions are provided;
when the dimensions of the cavities corresponding to the dimensions of one axial resonator in the resonators and the other one or two axial resonators or the three axial resonators change, the numbers and frequencies of the corresponding fundamental modes and multimodes and the Q values will also correspondingly change;
the decrease of the frequency when the metal and the dielectric resonance bars in the through hole of the dielectric resonance block are completely fitted is greater than the decrease of the frequency when there is a gap; when the end surfaces of the metal resonance bars and the end surfaces of dielectric resonance bars are in contact with the inner wall of the cavity, the frequency decreases; after the flange plate is added on the end surfaces of the metal resonance bar and the dielectric resonance bar, the frequency is further reduced; and if the flange plate has a larger area, the frequency decreases more.

9. The resonance unit according to claim 3, wherein a resonance unit with a single axial direction or two mutually vertically intersecting resonance units with single axial directions or three mutually vertically intersecting resonance units with single axial directions are provided; when the dimension of the inner wall of the cavity and the dimensions of the resonators corresponding to three axial directions change or the dimensions in the horizontal and vertical directions, the frequency of the fundamental mode and the frequency of multiple high-order modes will change; and the frequencies corresponding to the resonators with different dielectric constants, and the Q values change differently.

10. The resonance unit according to claim 3, wherein a resonance unit with a single axial direction or two mutually vertically intersecting resonance units with single axial directions or three mutually vertically intersecting resonance units with single axial directions are provided; when the dimension of the inner wall of the cavity and the dimensions of the resonators corresponding to the three axial directions change or the dimensions in the horizontal and vertical directions change, while the frequency of the fundamental mode remains unchanged, spans between the frequencies of the high-order modes and the frequency of the fundamental mode as well as spans between the frequencies of the high-order modes change for multiple times; spans between the frequencies of the resonators with different dielectric constants change differently;
when the dimensions of the cavities corresponding to the dimensions of one axial resonator and the other one or two axial resonators or the three axial resonators change, the spans between the frequency of the corresponding fundamental mode and the frequencies of the multimodes will also correspondingly change.

11. The resonance unit according to claim 1, wherein a resonance unit with a single axial direction or two mutually vertically intersecting resonance units with single axial directions or three mutually vertically intersecting resonance units with single axial directions are provided; when the dimension of the inner wall of the cavity and the dimensions of the resonators corresponding to the three axial directions change or the dimensions in the horizontal and vertical directions change, while the dimension of the cavity and the frequency of the fundamental mode remain unchanged, the fundamental mode and the high-order modes of the resonance unit may form at least one multimode with the same frequency or with close frequencies; when the dimensions of the cavities corresponding to the dimensions of one axial resonator and the other one or two axial resonators or the three axial resonators change, the corresponding fundamental mode and the number of the corresponding multimodes will also correspondingly change.

12. The resonance unit according to claim 1, wherein the resonator or cavity is cut at structural position perpendicular to an electric field or magnetic field or an edge is added, so as to form an adjacent coupling, and the cavity and the resonator are cut into triangles or quadrangles; or the edge of the cavity or the resonator is partially or overall cut off or added; the cavity and the resonator are simultaneously or separately subjected to edge cutting; after the adjacent coupling is formed by edge cutting, the frequencies and the Q values will correspondingly change; the adjacent coupling is changed into intersecting coupling;
intersecting structural positions of three resonance axial electric fields or magnetic fields formed by intersecting three surfaces of the cavities corresponding to the single axial resonator and the other one or two axial resonators are subjected to corner cutting or supplementation or are subjected to corner cutting and supplementation and closed with the corresponding cavities to form the intersecting coupling, and the corresponding frequencies and Q values will also correspondingly change; at the same time, the adjacent coupling is changed; and
when the corners and edges of the resonators are slotted or perforated or protrude, the strength of the adjacent coupling and the strength of the intersecting coupling are changed.

13. The resonance unit according to claim 1, wherein at least one tuning device is arranged at a position with concentrated field strength of the resonator.

14. The resonance unit according to claim 1, wherein a resonance unit with a single axial direction or two mutually vertically intersecting resonance units with single axial directions or three mutually vertically intersecting resonance units with single axial directions are provided; the shape of the corresponding cavity includes, at least one of the following: a cuboid, a cube, and a polygon; the surface of the inner wall of the cavity or part of an internal region may be set to be a recess or a protrusion or a cut corner or a slot; at least one tuning device is arranged at a position with concentrated field strength of the dielectric resonator and is mounted on the cavity; a material of the cavity is metal or non-metal; the surface of the space is electroplated with copper or silver; and the cavities in different shapes will affect the Q values, the frequencies, and the number of modes.

15. The resonance unit according to claim 1, wherein shapes combined by the cross sections of a resonance unit with a single axial direction or two mutually vertically intersecting resonance units with single axial directions or three mutually vertically intersecting resonance units with single axial directions and a vertical axial direction include, at least one of the following: a cylinder, an ellipsoid, a cube, a cuboid, and a polygon; the resonance unit is set to be solid or hollow;
the dielectric resonance block is provided with a through hole and a blind hole, and slots or holes are formed in the corner, edge and surface of the dielectric resonance block; or a plurality of slots or holes are symmetrically formed in different corners, edges and surfaces of the dielectric resonance block; or a plurality of slots or holes are formed in the same surface of the dielectric resonance block; or a slot or hole is formed inside the dielectric resonance block; or slots or holes are symmetrically formed in different axial directions of the dielectric resonance block; or a plurality of slots or holes are formed in the same surface of the dielectric resonance block; or a protrusion is formed in the surface; or different numbers of protruding cylinders and protruding polygons are arranged at any position on any surface;
the shape of the dielectric resonance bar or metal resonance bar is a cylinder, an ellipsoid, a cube, a cuboid, and a polygon;
the resonator with the single axial direction or the vertically intersecting resonators with the single axial directions or the three mutually vertically intersecting resonators with the single axial directions are solid or hollow;
materials of the dielectric resonance block and the dielectric resonance bar are ceramic, composite dielectric materials, and dielectric materials with a dielectric constant greater than 1; the dielectric surface may also be metalized;
a material of the metal resonance bar is aluminum, copper, iron, and other metal materials; or a surface of the metal resonance bar is metalized again;
the resonators are in different shapes, are made of different materials, and have different dielectric constants, which will also affect the frequencies, Q values and numbers of the fundamental mode and the high-order modes or the high-order modes and higher-order modes.

16. The resonance unit according to claim 1, wherein the dielectric and/or metal supporting frames are located on the end surface, edge and sharp corner of the resonator or the sharp corner of the cavity body and are arranged between the dielectric resonator and the cavity; and the resonator is supported by the supporting frame in the cavity body; the supporting frame and the resonator or the cavity are combined to form an integrated structure or a split type structure;
the dielectric supporting frame is made of a dielectric material; the material of the dielectric supporting frame is air, plastic, ceramic, or a composite dielectric material;
the metal supporting frame is made of aluminum, copper, silver, and other conductive materials; the dielectric and metal materials may also be combined to form a mixed material supporting frame;
when the supporting frame is mounted at different positions of the resonator, the frequency span between the corresponding fundamental mode and high-order modes or the frequency span between the high-order modes and higher-order modes will also be different;
the materials and dielectric constants of different dielectric supporting frames and different structures will also affect the frequency span between the corresponding fundamental mode and high-order modes or the frequency span between the high-order modes and higher-order modes.

17. The resonance unit according to claim 16, wherein the supporting frame is connected to the resonator and the cavity in a manner of pressing, adhesion, splicing, welding, buckling, or screw connection; and the supporting frame is connected to one or more end surfaces of the resonator with the single axial direction or the vertically intersecting resonators with the single axial directions or the three mutually vertically intersecting resonators with the single axial directions.

18. The resonance unit according to claim 1, wherein the supporting frame is mounted at any position corresponding to the resonator and the inner wall of the cavity, is matched with any shape of the resonator and any shape of the cavity for connection and fixing; the supporting frame includes a solid with two parallel surfaces or a center-through structure; the number of the supporting frame at the same end surface or different end surfaces, edges, and sharp corners on the resonator is one or a plurality of different combinations; frequencies, number of modes and Q values corresponding to different numbers of supporting frames will also be different; and when the dimension of the inner wall of the cavity and the dimensions of the resonators corresponding to the three axial directions change or the dimensions in the horizontal and vertical directions change, the Q values of the fundamental mode and high-order modes will change for multiple times.

19. The resonance unit according to claim 1, wherein the supporting frame of the resonator and the inner wall of the cavity are in contact to achieve heat conduction.

20. A dielectric filter comprising the resonance unit according to claim 1, wherein a resonance unit with a single axial direction or two mutually vertically intersecting resonance units with single axial directions or three mutually vertically intersecting resonance units with single axial directions may be combined to form 1-N single-pass band filters with different frequencies; the single-pass band filters with different frequencies are combined to form any combination of a multi-pass band filter, a duplexer or a multiplexer; the corresponding resonance unit may be further subjected to any permutation and combination in different forms together with a metal or dielectric single-mode resonance cavity, double-mode resonance cavity or three-mode resonance cavity, so as to form a plurality of required single-pass band or multi-pass band filters or duplexers or multiplexers or any combinations in different dimensions.

21. The dielectric filter according to claim 20, wherein cavities corresponding to the resonance unit with the single axial direction or the two mutually vertically intersecting resonance units with the single axial directions or the three mutually vertically intersecting resonance units with the single axial directions may be randomly combined with the single-mode or multimode cavities of the metal resonator and the single-mode or multimode cavities of the resonator.
